(19) United States
(12) Patent Application Publication
(10) Pub. No.: US 2017/0185103 A1
(43) Pub. Date: Jun. 29, 2017

(54) WEARING-SENSING HAND-ATTACHED WEARABLE DEVICE FOR IRIS RECOGNITION, SECURITY REINFORCING SET USING SAME, AND METHOD FOR CONTROLLING SAME

(71) Applicants: Dae Hoon KIM, Seoul (KR); IRITECH, INC., Fairfax, VA (US)

(72) Inventors: Dae Hoon KIM, Seoul (KR); Hyeong In CHOI, Seoul (KR); Byoung Jin JUN, Seoul (KR); Jung Woon RYU, Seoul (KR); Seung Min PAIK, Seoul (KR); Haeng Moon KIM, Gwacheon-si (KR)

(21) Appl. No.: 15/325,430

(22) PCT Filed: Jul. 8, 2015
(86) PCT No.: PCT/KR2015/007062

§ 371 Date: Jan. 10, 2017

(30) Foreign Application Priority Data
Jul. 10, 2014 (KR) 10-2014-0086564

(51) Int. Cl. G06F 1/16; G06F 21/32; H04W 12/08; H04L 29/06; H04W 12/06; G06F 3/01; H04B 1/3827

(52) U.S. Cl. CPC G06F 1/163; G06F 1/1686; G06F 3/011; G06F 21/32; H04B 1/3827; H04L 63/0861; H04W 12/06; H04W 12/08; G06F 21/30

(57) ABSTRACT

The present invention relates to a wearing-sensing hand-attached wearable device for iris recognition, a security reinforcing set using the same, and a method for controlling the same.

Particularly, the present invention relates to a security reinforcing set using a wearing-sensing hand-attached wearable device for iris recognition, including: a wearing-sensing hand-attached wearable device for iris recognition including a camera installed on one side of the hand-attached wearable device and photographing an iris image, an infrared lighting for lighting at the time of photographing the iris image, which is installed on one side of the hand-attached wearable device, a wireless communication unit transmitting and receiving the iris image information photographed and acquired by the camera, and a wearing sensing unit sensing whether the hand-attached wearable device is worn on a wrist or finger or an iris recognition unit comparing registered and stored iris image information and information on the photographed iris image; and an authentication request device including a short range wireless communication unit performing short range wireless communication with the hand-attached wearable device, a token management unit generating and destroying tokens to be transmitted to the hand-attached wearable device, a decoding unit decoding encoded information received from the hand-attached wearable device, and an iris matching unit comparing the iris image information transmitted from the hand-attached wearable device and registered and stored iris image information, wherein the hand-attached wearable device and the authentication request device establish a primary authentication relationship or a secondary authentication relationship and a method for controlling the same.

### TECHNICAL FIELD

The present invention relates to a wearing-sensing hand-attached wearable device for iris recognition, a security reinforcing set using the same, and a method for controlling the same.

Particularly, the present invention relates to a security reinforcing set using a wearing-sensing hand-attached wearable device for iris recognition, including: a wearing-sensing hand-attached wearable device for iris recognition including a camera installed on one side of the hand-attached wearable device and photographing an iris image, an infrared lighting for lighting at the time of photographing the iris image, which is installed on one side of the hand-attached wearable device, a wireless communication unit transmitting and receiving the iris image information photographed and acquired by the camera, and a wearing sensing unit sensing whether the hand-attached wearable device is worn on a wrist or finger or an iris recognition unit comparing registered and stored iris image information and information on the photographed iris image; and an authentication request device including a short range wireless communication unit performing short range wireless communication with the hand-attached wearable device, a token management unit generating and destroying tokens to be transmitted to the hand-attached wearable device, a decoding unit decoding encoded information received from the hand-attached wearable device, and an iris matching unit comparing the iris image information transmitted from the hand-attached wearable device and registered and stored iris image information, wherein the hand-attached wearable device and the authentication request device establish a primary authentication relationship or a second authentication relationship and a method for controlling the same.

### BACKGROUND ART

In recent years, in Internet of things (IoT) communication which has come up as a global topic, various technologies associated with control between different devices through wireless communication has made an appearance and in particular, applications for various services such as mobile payment or a smart key have rapidly increased. However, due to various problems such as an access of a user which is not permitted, hacking through a device which is not authenticated and security infringement on a network, a security problem of the Internet of things (IoT) communication has not yet been easily solved.

Accordingly, in order to solve the problems, a method using a smart phone recognized as an indispensable item for a life has appeared as an alternative. Since general users continuously possess the smart phone, the user can be verified unlike another device and actually, the smart phone is used as a card that opens or locks a door by using the smart phone as a key or performs a payment in a bank or an item store. However, personal information of the general users may be leaked because the smart phone is lost or stolen or due to the hacking, and as a result, in recent years, efforts have been made in order to apply to the smart phone an iris recognition technology which is known recognition rate of the iris recognition technology is much higher than the recognition rate of another bio recognition technology among various bio recognition technologies in the smart phone, but the application is not easy due to various limits.

An infrared illumination needs to be separately provided for iris recognition in the smart phone due to a first limit and it is not easy that a camera module for the iris recognition is additionally configured due to a design and a structure of the current smart phone in which an RGB camera, buttons, an audio receiver, an illumination sensor, and the like are concentratively configured on a front surface of the smart phone. Second, when an iris image is photographed while viewing a display (LCD) due to the position of the camera which primarily exists on the top of the smart phone, a phenomenon in which a predetermined part of an iris is covered easily occurs and there is a cumbersome in which the iris recognition needs to be repeatedly performed all the time.

Third, there is a risk that personal iris information may be exposed when the smart phone is lost.

Therefore, various researches for applying the IoT communication by using a wearable device which has been technologically innovated have started in recent years in order to overcome a disadvantage of the smart phone. A research into the wearable device anticipated as next generation technology which will substitute for the smart phone first started in MIT, Carnegie Mellon University, and the like, but since 2010, technological innovation has started to rapidly become a reality after activation of the smart phone. In particular, since 2010, independently using the wearable device which have been propelled in the existing research and development has been changed to a connected device type in which information collected by the wearable device is mutually transmitted to and exchanged with an electronic device such as the smart phone, and as a result, the wearable device interlocks with the electronic device such as the smart phone.

Therefore, if the iris recognition is performed by the wearable device and thereafter, authentication may be performed in another device in link with the iris recognition, there is an advantage that security can be reinforced through the iris recognition without adding a particular component. Actually, in most of current sensor devices, computer power is low or it is almost impossible to apply the iris recognition by using a low-capacity memory and a low-capacity storage device. Moreover, since the wearable device used while being attached to a hand is continuously attached to a body, it is almost impossible for a user who is not permitted to use the wearable device and there is a very lower possibility that the wearable device will be lost than the smart phone.

Further, since a display screen which the user may view at the time of coming close to the camera for the iris recognition is relatively smaller than that of the smart phone, the user may intuitively photograph the iris and there is no possibility that an iris area of the user which is photographed will also be covered.

As related prior art, disclosed is a technology associated with a wrist type wearable device of U.S. patent Ser. No. 13/407,026 disclosed, but this technology is also irrespective of a technical configuration of the present invention associated with the hand-attached wearable device for iris recognition, which has a wearing sensor. As another prior art, U.S. patent Ser. No. 11/128,898 discloses a technology regarding a method and an apparatus for controlling a wireless device by using a wearable device, but this technology is irrespective of a technical configuration of the present invention associated with user authentication using iris recognition and wearing authentication using wearing sensor.

As yet another prior art associated with the present invention, U.S. Ser. No. 12/722,624 and U.S. Ser. No. 13/297,952 are provided, but the technologies are also irrespective of the technical configuration of the present invention associated with user authentication using iris recognition and wearing authentication using wearing sensor.

Accordingly, a demand for the apparatus and the method for reinforcing wireless communication between devices has been actually increased, which have increased user convenience while considering the unique characteristics of the wearable device itself, which has different characteristics from the device in the related art, which are described above and sufficiently considering physical space and economic cost issues.

### DISCLOSURE

### Technical Problem

An object of the present invention is to provide a hand-attached wearable device which senses whether a user wears a hand-attached wearable device and uses the sensed wearing or not for authentication for reinforcing security in wireless communication.

Another object of the present invention is to provide a hand-attached wearable device which photographs an iris image of the user and uses the photographed iris image for authentication for reinforcing the security in the wireless communication. Yet another object of the present invention is to provide a hand-attached wearable device which uses information of a hand-attached wearable device worn by a user and uses the information for authentication for reinforcing the security in the wireless communication.

Still yet another object of the present invention is to provide a security reinforcing set using a hand-attached wearable device used for authentication for reinforcing the security in wireless communication with another device requesting an authentication request by photographing the iris image of the user.

Still yet another object of the present invention is to provide a security reinforcing set using a hand-attached wearable device used for authentication for reinforcing the security in the wireless communication with another device requesting the authentication request by using information on the hand-attached wearable device worn by the user.

Still yet another object of the present invention is to provide a security reinforcing set using a hand-attached wearable device which senses whether the user wears the hand-attached wearable device and uses the sensed wearing or not for authentication for reinforcing the security in the wireless communication with another device requesting the authentication request.

Still yet another object of the present invention is to provide a security reinforcing set using a hand-attached wearable device used for authentication for reinforcing security in wireless communication configured to verify a registered wearing user again when the user takes off the hand-attached wearing device without requesting additional authentication between the hand-attached wearable device and a device requesting an authentication request after a registered use of the hand-attached wearable device is verified.

Still yet another object of the present invention is to provide a security reinforcing set using a hand-attached wearable device used for authentication for reinforcing security in wireless communication configured to verify a registered wearing user again when an expiration date of iris recognition of the user elapsed without requesting the additional authentication between the hand-attached wearable device and the device requesting an authentication request after the registered use of the hand-attached wearable device is verified.

Still yet another object of the present invention is to provide a security reinforcing set using a hand-attached wearable device used for authentication for reinforcing security in wireless communication configured to verify the registered wearing user again when information on the device may not be used without requesting the additional authentication due to movement of the hand-attached wearable device and the device requesting the authentication request after the registered use of the hand-attached wearable device is verified.

Still yet another object of the present invention is to provide a hand-attached wearable device which encodes iris image information in order to reinforce security when the iris image of the user is photographed and transmitted in the wireless communication.

Still yet another object of the present invention is to provide a security reinforcing set using the hand-attached wearable device which encodes the iris image information in order to reinforce the security when the iris image of the user is photographed and transmitted to another device requesting the authentication request by the wireless communication.

### Technical Solution

A means for solving the problem relates to a wearing-sensing hand-attached wearable device for iris recognition and particularly, to providing a wearing-sensing hand-attached wearable device for iris recognition, including: a camera installed on one side of the hand-attached wearable device and photographing an iris image, an infrared lighting for lighting at the time of photographing the iris image, which is installed on one side of the hand-attached wearable device, a wireless communication unit transmitting and receiving the iris image information photographed and acquired by the camera, and a wearing sensing unit sensing whether the hand-attached wearable device is worn on a wrist or finger or an iris recognition unit comparing registered and stored iris image information and information on the photographed iris image.

Another means for solving the problem is to a wearing-sensing hand-attached wearable device for iris recognition and particularly, is to provide a security reinforcing set using a wearing-sensing hand-attached wearable device for iris recognition, including: a wearing-sensing hand-attached wearable device for iris recognition including a camera installed on one side of the hand-attached wearable device and photographing an iris image, an infrared lighting for lighting at the time of photographing the iris image, which is installed on one side of the hand-attached wearable device, a wireless communication unit transmitting and receiving the iris image information photographed and acquired by the camera, and a wearing sensing unit sensing whether the hand-attached wearable device is worn on a wrist or finger or an iris recognition unit comparing registered and stored iris image information and information on the photographed iris image; and an authentication request device including a short range wireless communication unit performing short range wireless communication with the hand-attached wearable device, a token management unit generating and destroying tokens to be transmitted to the hand-attached wearable device, a decoding unit decoding encoded information received from the hand-attached wearable device, and an iris matching unit comparing the iris image information transmitted from the hand-attached wearable device and registered and stored iris image information, wherein the hand-attached wearable device and the authentication request device establish a primary authentication relationship.

Yet another means for solving the problem is to provide a security reinforcing set using a wearing-sensing hand-attached wearable device for iris recognition, including: a wearing-sensing hand-attached wearable device for iris recognition including a camera installed on one side of the hand-attached wearable device and photographing an iris image, an infrared lighting for lighting at the time of photographing the iris image, which is installed on one side of the hand-attached wearable device, a wireless communication unit transmitting and receiving the iris image information photographed and acquired by the camera, and a wearing sensing unit sensing whether the hand-attached wearable device is worn on a wrist or finger or an iris recognition unit comparing registered and stored iris image information and information on the photographed iris image; and an authentication request device including a short range wireless communication unit performing short range wireless communication with the hand-attached wearable device, a token management unit generating and destroying tokens to be transmitted to the hand-attached wearable device, a decoding unit decoding encoded information received from the hand-attached wearable device, and an iris matching unit comparing the iris image information transmitted from the hand-attached wearable device and registered and stored iris image information, wherein the hand-attached wearable device and the authentication request device establish a second authentication relationship.

Still yet another object of the present invention is to provide a security reinforcing set using a hand-attached wearable device configured to verify a registered wearing user again when the entitlement of the registered user is released and resetting the secure communication session is requested without requesting additional authentication between the hand-attached wearable device and a device requesting an authentication request after a registered use of the hand-attached wearable device is verified.

Still yet another object of the present invention is to provide a security reinforcing unit which encodes iris image information in order to reinforce security when the iris image of the user is photographed and transmitted in the wireless communication.

Still yet another object of the present invention is to provide a security reinforcing unit which encodes iris image information in order to reinforce security when the iris image of the user is photographed and transmitted to another device requesting an authentication request by the hand-attached wearable device in the wireless communication.

### Advantageous Effects

As an effect, a wearing-sensing hand-attached wearable device for iris recognition, including: a camera installed on one side of the hand-attached wearable device and photographing an iris image, an infrared lighting for lighting at the time of photographing the iris image, which is installed on one side of the hand-attached wearable device, a wireless communication unit transmitting and receiving the iris image information photographed and acquired by the camera, and a wearing sensing unit sensing whether the hand-attached wearable device is worn on a wrist or finger or an iris recognition unit comparing registered and stored iris image information and information on the photographed iris image is provided to perform an authentication for reinforcing the security in the wireless communication.

As another effect, a security reinforcing set using a wearing-sensing hand-attached wearable device for iris recognition, including: a wearing-sensing hand-attached wearable device for iris recognition including a camera installed on one side of the hand-attached wearable device and photographing an iris image, an infrared lighting for lighting at the time of photographing the iris image, which is installed on one side of the hand-attached wearable device, a wireless communication unit transmitting and receiving the iris image information photographed and acquired by the camera, and a wearing sensing unit sensing whether the hand-attached wearable device is worn on a wrist or finger or an iris recognition unit comparing registered and stored iris image information and information on the photographed iris image; and an authentication request device including a short range wireless communication unit performing short range wireless communication with the hand-attached wearable device, a token management unit generating and destroying tokens to be transmitted to the hand-attached wearable device, a decoding unit decoding encoded information received from the hand-attached wearable device, and an iris matching unit comparing the iris image information transmitted from the hand-attached wearable device and registered and stored iris image information, wherein the hand-attached wearable device and the authentication request device establish a primary authentication relationship is provided to perform an authentication for reinforcing the security in the wireless communication with another device requesting an authentication request.

As yet another effect, a security reinforcing set using a wearing-sensing hand-attached wearable device for iris recognition, including: a wearing-sensing hand-attached wearable device for iris recognition including a camera installed on one side of the hand-attached wearable device and photographing an iris image, an infrared lighting for lighting at the time of photographing the iris image, which is installed on one side of the hand-attached wearable device, a wireless communication unit transmitting and receiving the iris image information photographed and acquired by the camera, and a wearing sensing unit sensing whether the hand-attached wearable device is worn on a wrist or finger or an iris recognition unit comparing registered and stored iris image information and information on the photographed iris image; and an authentication request device including a short range wireless communication unit performing short range wireless communication with the hand-attached wearable device, a token management unit generating and destroying tokens to be transmitted to the hand-attached wearable device, a decoding unit decoding encoded information received from the hand-attached wearable device, and an iris matching unit comparing the iris image information transmitted from the hand-attached wearable device and registered and stored iris image information, wherein the hand-attached wearable device and the authentication request device establish a second authentication relationship is provided not to request an additional authentication between the hand-attached wearable device and a device requesting the authentication request.

As still yet another effect of the present invention, a security reinforcing unit that encodes the iris image information is provided to transmit the iris image information in the wireless communication, transmit the iris image information to another device requesting the authentication request in the wireless communication, or encode the iris image information in order to reinforce the security in a wireless communication configured to perform the registered wearing user verification again when an expiration date of the iris recognition of the user has elapsed.

### DESCRIPTION OF DRAWINGS

FIG. 1(a) illustrates an example of a wrist type wearable device according to an embodiment of the present invention and FIG. 1(b) illustrates an example of a ring type wearable device according to an embodiment of the present invention.

FIG. 2 illustrates an example for describing a phenomenon in which an iris area is covered, which occurs when picking up an iris image while viewing a display screen of a smart phone according to an embodiment of the present invention.

FIG. 3 illustrates an example for describing a concept of performing iris recognition in connection with various devices with a drawing according to an embodiment of the present invention.

FIG. 4 illustrates an example for describing a difference in iris recognition executing method of a hand-attached wearable device after photographing an iris image according to an embodiment of the present invention.

FIG. 5 is a block diagram schematically illustrating the configuration of the hand-attached wearable device depending on a method for performing iris recognition according to an embodiment of the present invention.

FIG. 6 illustrates an example of a wearing sensing unit configured by a magnetic sensor of the hand-attached wearable device with a drawing according to an embodiment of the present invention.

FIG. 7 illustrates an example of a wearing sensing unit configured by a capacitive touch sensor of the hand-attached wearable device with a drawing according to an embodiment of the present invention.

FIG. 8 illustrates an example of a wearing sensing verifying unit configured by a temperature sensor of the hand-attachable wearable device through the picture according to an embodiment of the present invention.

FIG. 9 illustrates an example of a wearing sensing unit configured by a proximity sensor of the hand-attached wearable device with a drawing according to an embodiment of the present invention.

FIG. 10 is a block diagram schematically illustrating a wireless communication unit according to an embodiment of the present invention.

FIG. 11 illustrates an example schematically illustrating a concept and a configuration of a security reinforcing set considering the case where the authentication request may not perform the iris recognition according to an embodiment of the present invention.

FIG. 12 illustrates an example schematically illustrating the concept and the configuration of the security reinforcing set considering the case where the authentication request device performs the iris recognition according to the embodiment of the present invention.

FIG. 13 is a block diagram schematically illustrating a configuration of a short range wireless communication unit according to an embodiment of the present invention.

FIG. 14 is a flowchart for describing a method of completing registered wearing user verification in a security reinforcing set which considers a case where the authentication request device according to the embodiment of the present invention cannot perform iris recognition.

FIG. 15 is a flowchart for describing a method of completing registered wearing user verification in a security reinforcing set which considers a case where the authentication request device according to the embodiment of the present invention performs iris recognition.

FIG. 16 is a flowchart for describing a method of establishing a secondary authentication relationship after establishing the primary authentication relationship according to an embodiment of the present invention.

FIG. 17 is a flowchart for describing a method of completing registered wearing user verification in a security reinforcing set which considers a case where the authentication request device cannot perform iris recognition according to whether the secure communication session according to the embodiment of the present invention is performed (the secondary authentication relationship is established).

FIG. 18 is a flowchart for describing a method of completing registered wearing user verification in a security reinforcing set which considers a case where the authentication request device performs iris recognition according to whether the secure communication session according to the embodiment of the present invention is performed (the secondary authentication relationship is established).

FIG. 19 illustrates a concept of establishing and applying a primary authentication relationship between the hand-attached wearable device and a plurality of authentication request devices according to an embodiment of the present invention.

FIG. 20 illustrates a concept of establishing and applying a secondary authentication relationship between the hand-attached wearable device and a plurality of authentication request devices according to an embodiment of the present invention.

### BEST MODE

The present invention relates to a hand-attachable wearable device capable of iris identification outdoors and indoors, which includes an electronic component case and a band covering a wrist or a finger, and particularly, to a hand-attachable wearable device capable of iris identification outdoors and indoors, which includes an indoor and outdoor combined pick-up unit installed at one side of the case, which is used for picking up an iris image in which reflection noise is reduced indoors and outdoors, an infrared lighting installed at one side of the case and required for definitely picking up the iris image, and an iris recognition unit performing the iris recognition by comparing registered and registered iris image information and information on the picked-up iris image.

### MODE FOR INVENTION

Detailed contents for carrying out the present invention will be described.

Hereinafter, a configuration and an operation of an embodiment of the present invention will be described with reference to the accompanying drawings and the configuration and the operation of the present invention illustrated and described in the drawings are described as at least one embodiment and the technical spirit of the present invention and a core configuration and an operation thereof are not limited thereto.

Accordingly, various modifications and transformations of core components of a wearing-sensing hand-attached wearable device for iris recognition and a security reinforcing set using the same can be made by those skilled in the art to which an embodiment of the present invention belongs within the scope without departing from essential characteristics of an embodiment of the present invention.

Further, terms such as A, B, (a), (b), and the like may be used in describing the components of the exemplary embodiments according to the present invention. The terms are only used to distinguish a component from another component, but nature or an order of the component is not limited by the terms. When it is disclosed that any component is “connected”, “included”, or “configured” to other components, it should be understood that the component may be directly connected or linked to other components, but another component may be “connected”, “included”, or “configured” between the respective components.

Further, in the present invention, in different drawings, different reference numerals denote the same components for easy appreciation.

### Embodiment

Detailed contents for carrying out the present invention will be described.

First, in the present invention, for easy description, a hand attached type wearable device is defined to mean a wearable device (hereinafter, referred to as a ‘wrist-type wearable device’) worn on a wrist and a wearable device (hereinafter, referred to as a ‘ring-type wearable device’) worn on a finger.

Further, a clock or ring shape will be primarily described, which is a representative type of the wrist-type wearable device and the ring-type wearable determined to best appreciate the gist of the present invention among various hand attached type wearable devices including clock, bracelet, band, smart ring, arm band sport type measurement devices, etc.

Accordingly, even though the hand attached-type wearable device having the clock or ring shape is given as an example, hand attached-type wearable devices having various different shapes can also be sufficiently described by the same method, and as a result, it should be appreciated that the same application is available.

Further, various hand attached-type wearable devices fundamentally include a case or protecting electronic components and a band covering the wrist or finger.

Further, the various hand attached-type wearable devices may be constituted by an electronic component control means (hardware or/and software) constituted by a memory or/and a CPU of the hand-attached-type wearable device. In this case, all of memories including a RAM, a ROM, a flash, and the like, a type and a specification of the CPU, existence or not and a specification of a communication module, existence or not, and a type and a version of an OS, installed software, and a UI which coincide with the purpose and the gist of the present invention to be described below may be used.

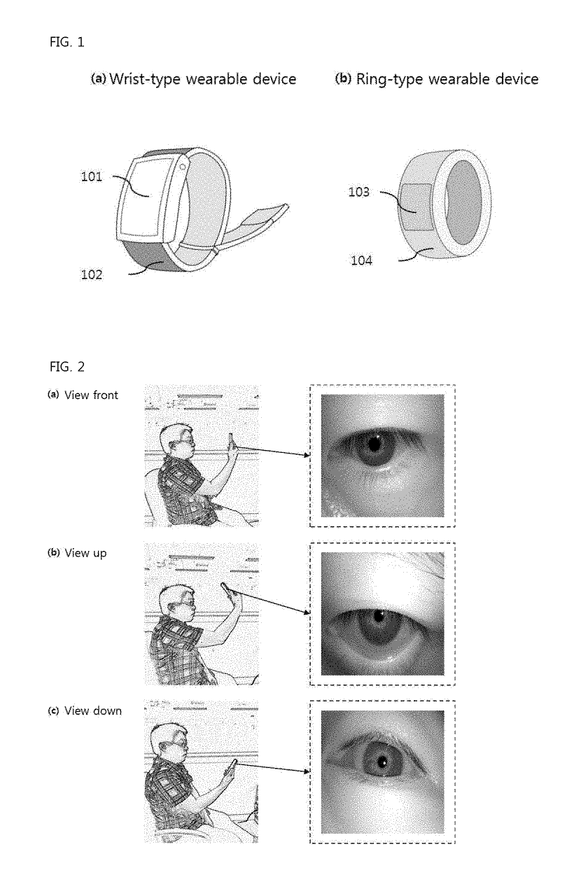

FIG. 1 illustrates an example of a hand-attached wearable device according to an embodiment of the present invention.

First, an application limit of a smart phone of iris recognition will be described in detail.

First, an infrared illumination needs to be separately provided, which is required when performing the iris recognition in order to perform the iris recognition in the smart phone and it is not easy that a camera module for the iris recognition is additionally configured due to a design and a structure of the current smart phone in which an RGB camera, buttons, an audio receiver, an illumination sensor, and the like are concentratively configured on a front surface of the smart phone.

Second, when an iris image is photographed while viewing a display (LCD) due to the position of the camera which primarily exists on the top of the smart phone, a phenomenon in which a predetermined part of an iris is covered easily occurs and there is a cumbersome in which the iris recognition needs to be repeatedly performed all the time.

FIG. 2 illustrates an example for describing a phenomenon in which an iris area is covered, which occurs when picking up an iris image while viewing a display screen of a smart phone according to an embodiment of the present invention.

As illustrated in FIG. 2, when the user views the front surface of the smart phone, the camera that photographs the iris is positioned above the display (LCD), and as a result, an upper eyebrow and an upper eyelid cover an upper portion of the iris. Further, in order to avoid the problem, when the display (LCD) of the smart phone is raised up to be adjusted to the eye position, the user naturally covers the upper portion of the iris while raising his/her eyes. On the contrary, in general, when the user adjusts the display (LCD) of the smart phone downward to be adjusted to the eye position as an attitude in which the user uses the smart phone, a phenomenon in which the iris is covered by the eyebrow may be reduced, but a lower portion of the iris in a lower part is covered.

Further, there is a limit in which the iris recognition needs to be repeatedly performed all the time whenever opening the smart phone. For example, in the case of performing user authentication using the iris recognition for Single Sign On (SSO) in the smart phone, additional authentication may not be requested for convenience of a user or on the contrary, the iris recognition may be requested to be performed every authentication in order to reinforce the security. However, both methods are very inconvenient in terms of the security and the user convenience.

Third, there is a risk that personal iris information may be exposed when the smart phone is lost.

Next, advantages at the time of applying the iris recognition to the hand-attached wearable device will be described in comparison with the limits of the smart phone described above.

First, the hand-attached wearable device that is usable as a connected device, which is a type of real-time mutual exchange with the smart phone may be configured to directly perform the iris recognition to be performed in the existing smart phone and thereafter, use associated authentication information in conjunction with the smart phone, thereby overcoming the limits of the smart phone. Actually, in most of current sensor devices, computer power is low or it is almost impossible to apply the iris recognition by using a low-capacity memory and a low-capacity storage device. If the iris recognition is performed by the wearable device and thereafter, authentication may be performed in another device in link with the iris recognition, there is an advantage that security can be reinforced through the iris recognition without adding a particular component.

Second, in the hand-attached wearable device, the display screen is relatively smaller and the distance between the center of the display screen which the users views at the time of acquiring the iris image and the pick up unit is within 2 to 3 cm and further, the user intuitively performs pick-up so that the eye of the user is wholly positioned in the display screen.

Third, since the hand-attached wearable device is continuously used while being attached to a hand, there is a very lower possibility that the hand-attached wearable device will be lost than the smart phone, therefore, security authentication for the user may be continued as it is by verifying whether the hand-attached wearable device is worn without the need of requesting the iris recognition all the time to increase the convenience of the user and reinforce the security.

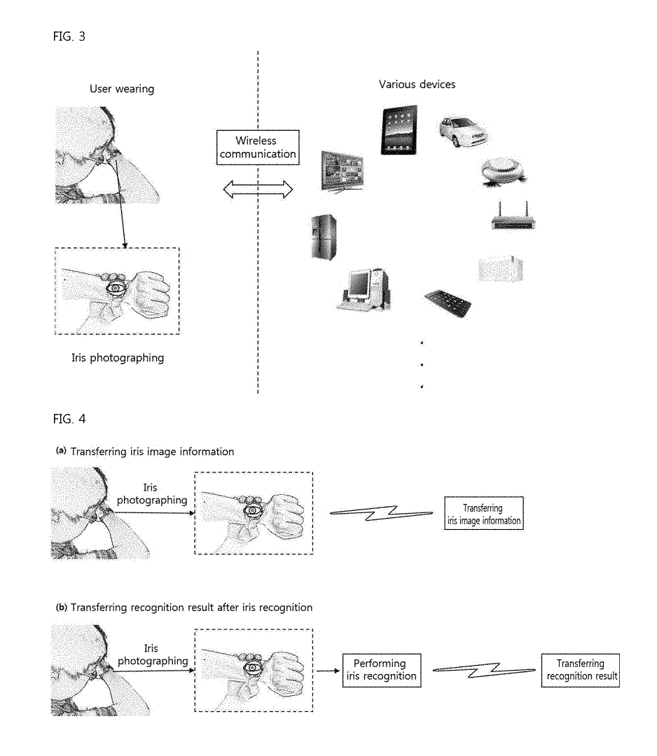

FIG. 3 illustrates an example for describing a concept of performing iris recognition in connection with various devices with a drawing according to an embodiment of the present invention.

As illustrated in FIG. 3, the user is authenticated through the iris recognition in order to interact with various devices while wearing the wearable device on his or her wrist. In this case, the user communicates with various devices by the wireless communication and transmits and receives even various authentication related information.

Therefore, in order to carry out the process, it can be seen that the wearable device needs to basically include a means for verifying whether the user wears the wearable device on his or her wrist or finger, a means for performing the iris recognition by using a camera photographing the iris of the user and an infrared lighting, an iris image photographed by the camera, and a means for performing the wireless communication with various devices.

Next, the configuration of the wearing-sensing hand-attached wearable device for iris recognition will be described in detail.

In order for the hand-attached wearable device to perform the iris recognition, the camera and the infrared lighting for photographing and acquiring the iris image of the user are required and a means for performing the iris recognition, which performs the iris recognition with the photographed iris image is required.

FIG. 4 illustrates an example for describing a difference in iris recognition executing method of a hand-attached wearable device after photographing an iris image according to an embodiment of the present invention.

As illustrated in FIG. 4, after the hand-attached wearable device just photographs and acquires the iris image, the hand-attached wearable device transfers the iris image to various devices to allow the devices to perform the iris recognition by using the transferred iris image or after the hand-attached wearable device directly performs the iris recognition by using the iris image, the hand-attached wearable device may transmit the recognition result to the devices. Accordingly, the configuration of the device cannot but vary depending on the method of performing the iris recognition. In this case, the iris image is not used as it is but the iris image may be used while being converted into an iris template. The iris template as an iris image format stored in the memory for use in performing the similarity of the iris image to determine whether the iris images are the same as each other means an iris image format which contains a personal unique bio feature, but has the size of the memory which is relatively smaller than an original iris image measured by the camera and the iris template processes the iris image by Fourier transform or wavelet transform in order to increase a processing speed while authentication and decrease a memory capacity while storing.

In the present invention, the iris image or the iris template is defined as ‘iris image information’ for convenience of description.

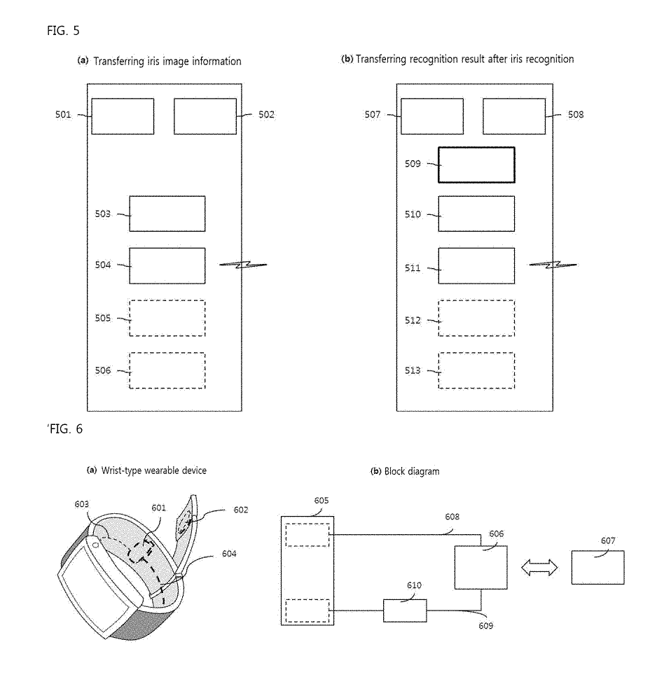

FIG. 5 is a block diagram schematically illustrating the configuration of the hand-attached wearable device depending on a method for performing iris recognition according to an embodiment of the present invention.

As illustrated in FIG. 5, when the hand-attached wearable device photographs and acquires and transmits the iris image information to various devices to allow the devices to perform the iris recognition, the hand-attached wearable device is constituted by a camera 501 installed on one side of the hand-attached wearable device and photographing the iris image, an infrared lighting 502 for lighting at the time of photographing the iris image, which is installed on one side of the hand-attached wearable device, a wearing sensing unit 503 sensing whether the hand-attached wearable device is worn on the wrist or finger, and a wireless communication unit 504 transmitting and receiving the iris image information photographed and acquired by the camera. Further, the hand-attached wearing device may be additionally constituted by a security reinforcing unit 505 or a display 506 for encoding the iris image information transmitted through the wireless communication.

On the contrary, when the hand-attached wearable device is configured to directly carry out the iris recognition using the iris image information and then transmit the iris recognition result to the device, hand-attached wearable device is constituted by a camera 507 installed on one side of the hand-attached wearable device and photographing the iris image, an infrared lighting 508 for lighting at the time of photographing the iris image, which is installed on one side of the hand-attached wearable device, an iris recognition unit 509 comparing the registered iris image information with the photographed iris image information, a wearing sensing unit 510 sensing whether the hand-attached wearable device is worn on the wrist or finger, and a wireless communication unit 511 for transmission and reception with the device. Further, the hand-attached wearing device may be additionally constituted by a security reinforcing unit 512 or a display 513 for encoding the iris image information transmitted through the wireless communication.

Next, the configuration of the camera required for photographing and acquiring the iris image of the user in the hand-attached wearable device will be described in detail.

The hand-attached wearable device is fundamentally constituted by a lens for receiving the iris image in order to pick up the iris image, an image sensor for sensing the iris image input through the lens, and a memory for storing the sensed iris image.

The lens in the present invention is designed in such a manner that a lens view angle sufficiently outputs the entirety of one iris image of the user in the wrist type wearable device and as the image sensor, a CMOS image sensor is primarily used rather than a CCD image sensor.

The camera according to the present invention is not just limited to a camera complete product, but includes a camera lens or a camera module such as a smart device including a smart phone, a tablet, a PDA, a PC, and a notebook in which the iris recognition has been introduced or a research into the introduction has been in active progress in recent years.

In general, the resolution of the image required for the iris recognition follows the regulation of the ISO and the ISO regulation stipulates the resolution of the image as the number of pixels of an iris diameter based on the a VGA resolution image.

According to a standard of the ISO, in general, an image having 200 pixels or more is classified into a high-definition image, an image having 170 pixels is classified into a normal-definition image, and an image having 120 pixels is classified into a low-definition image.

Accordingly, in the present invention, in the hand-attached wearable device, a camera having a high-definition pixel, which may achieve the convenience of the user while acquiring the iris image is used as possible, but since there is a high possibility that various pixel numbers will be adopted due to the image quality of the iris or characteristics of other additional devices, the camera need not particularly be limited to the high-definition pixel.

In particular, in recent years, a high-definition camera module having a 12 M or 16 M-pixel resolution and a transmission speed of 30 frames per second is used for a digital video device and a smart device to sufficiently acquire the image for the iris recognition and the camera may be generally constituted by one or two or more multiple cameras.

Further, as the lens, the image sensor, and the memory used for photographing and acquiring the iris image, any lens or image sensor and memory may be used as long as the lens, the image sensor, and the memory meet the purpose and the gist of the present invention.

In addition, a buffer for temporarily storing the iris image photographed by the camera may be configured. In general, since a storage space is not large due to the characteristics of the buffer, in the present invention, the iris image photographed by the camera is stored for a certain period of time until the iris image is transmitted to the means for performing the iris recognition or the means for converting the iris image into the iris image information.

Therefore, according to the present invention, the configuration of the buffer may be constituted by two buffers which separately serve to play the roles described above or when a specific storage space is added to the buffer to store the iris image photographed by the camera in the specific storage space, that is, various configurations may be used to meet the purpose and the gist of the present invention.

In addition, in the present invention, a means for converting the iris image photographed and acquired by the camera into the iris image information may be additionally configured. In particular, when the photographed and acquired iris image is wirelessly transmitted, the iris image information is configured to be encoded and transmitted rather than iris image as much as possible for security.

Next, the configuration of the lighting required for photographing and acquiring the iris image of the user in the hand-attached wearable device will be described in detail.

The infrared lighting is fundamentally used, but when the hand-attached wearable device using not the infrared rays but the visible rays is used, it is preferable that an illumination unit turning on the infrared lighting is additionally configured.

As a method for controlling the light source, first, a method that turns off a visible lighting and turns on the infrared lighting is used when the visible lighting is used and the iris image is photographed or second, a method in which an infrared filter is attached to the visible lighting and only the infrared rays are used as the light source is used when the infrared filter is attached to the visible lighting and only the infrared rays are used as the light source.

Further, as the infrared lighting, the light source of the installed infrared lighting having one or more wavelengths which pass through the wavelength band of the band-pass filter is installed.

Next, the configuration of the display required for photographing and acquiring the iris image of the user in the hand-attached wearable device will be described in detail.

The existing devices for the iris recognition verifies whether one eye is focused on an appropriate area through a front display screen while the user applies his/her eye to a camera on a front surface of the device and to this end, a means for notifying an eye position of the user to the user is used, which serves to guide the eye position of the user so as to accurately acquire the iris image of the user according to the position of the camera.

In particular, the camera lens is positioned above or below a screen on the front surface in order to recognize the iris on a terminal having a large screen, such as the smart phone and when the camera lens is positioned above the front surface, a phenomenon in which an iris area is covered by an eyebrow or eyelid frequently occurs and when the camera lens is positioned below the font surface, there is an effort in which the user needs to raise a terminal a lot (see FIG. 2).

However, in the hand-attached wearable device, the display screen is relatively smaller and the distance between the center of the display screen which the users views at the time of acquiring the iris image and the photographing unit is within 2 to 3 cm and further, the user intuitively performs photographing so that the eye of the user is wholly positioned in the display screen.

As the display, a cold mirror (a visible-ray reflection filter) or displays including the LCD, an LED, an OLED, and the like may be installed so as to move a back-hand or wrist type wearable device to a position where the user may rapidly acquire an excellent image so as to allow the iris image to be viewed when the eye is photographed by the camera. In this case, a virtual guide line is made in the mirror or the LCD to allow the user to easily photograph the iris image by preventing the iris image from being distorted or the iris image from being blurredly photographed.

In the present invention, in particular, since the camera is installed on the bottom or at a left side or a right side of the display screen positioned so as for the user to easily photograph the iris image (may include the entirety of the eye portion area) required for the iris recognition while naturally viewing the display screen, the camera is sufficiently installed in terms of cost or in terms of a spatial limit due to a physical size, there is no difficult to apply the present description.

Next, the configuration required to sense whether the smart phone is worn on the wrist or finger in a hand-attached wearable device will be described in detail.

The hand-attached wearable device has a characteristic in that the user does not take off the hand-attached wearable device once the user wears the hand-attached wearable device unlike other devices.

Accordingly, since the user does not generally take off the wearable device once the user wears the wearable device, it may be very inconvenient for the user to continuously take an authentication like a cellular phone whenever using the wearable device.

On the contrary, since a risk of loss and robbery is small due to such a characteristic, the hand-attached wearable device may be safely used without additional personal authentication as long as taking off the hand-attached wearable device once the authentication is performed when first wearing the hand-attached wearing device unlike other security devices.

If a method that does not require additional authentication is used while a session is maintained by single sign-on (integrated authentication) that enables resources on various computers to be used through one authentication process in the terminal such as the smart phone, critical accidents associated with financial settlement and identification may be caused when the terminal is lost or robbed.

On the contrary, since the user does not easily take off the hand-attached wearable device, the risk of the loss and robbery is small and when the user intentionally takes off the hand-attached wearable device or the hand-attached wearable device is unintentionally released, whether the user intentionally takes off the hand-attached wearable device or the hand-attached wearable device is unintentionally released may be sensed by using a means (hereinafter, referred to as a ‘wearing sensing unit’) for determining whether to wear the hand-attached wearable device, and as a result, the hand-attached wearable device may be very conveniently used while maintaining advance security.

Connection lines to sense that a magnetic sensor, a capacitive touch sensor, a temperature sensor, and a proximity sensor are cut from a band is installed at one side of (inside or outside) the band of the hand-attached wearing device in addition to mechanical devices including a spring, a hinge, and the like to sense the wearing of the wrist type wearable device and the sensor that senses the wearing is mounted on a case of the wrist type wearable device or mounted on the band.

FIG. 6 illustrates an example of a wearing sensing unit configured by a magnetic sensor of the hand-attached wearable device with a drawing according to an embodiment of the present invention.

As illustrated in FIG. 6, when the user wears the hand-attached wearable device, the signal is generated while magnetic sensors 601 and 606 are coupled with magnets 602 and 607 (as a distance between the magnetic sensor and the magnet decreases) (ON), while when the user takes off the hand-attached wearable device (the distance between the magnetic sensor and the magnet increases), the signal disappears (OFF).

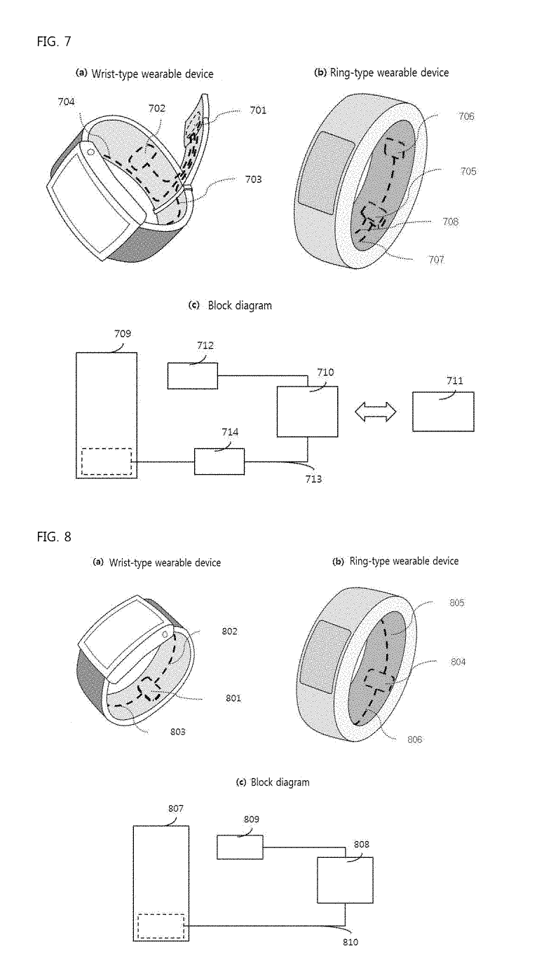

FIG. 7 illustrates an example of a wearing sensing unit configured by a capacitive touch sensor of the hand-attached wearable device with a drawing according to an embodiment of the present invention.

As illustrated in FIG. 7, when the user wears the hand-attached wearable device, the signal is generated as static electricity is generated while capacitive touch sensors 701, 705, and 710 are coupled with sensing magnets 702, 706, and 711 (ON), while when the user takes off the hand-attached wearable device, the signal disappears while the static electricity disappears (OFF).

FIG. 8 illustrates an example of a wearing sensing unit configured by a temperature sensor of the hand-attached wearable device with a drawing according to an embodiment of the present invention.

As illustrated in FIG. 8, when the user wears the hand-attached wearable device, if the temperature of the band increases by the temperature of the wrist or the finger and the temperature of the band is thus higher than a temperature of a predetermined reference value, temperature sensors 801, 804, and 808 sense the corresponding temperature to generate the signal (ON), while when the user takes off the hand-attached wearable device, the signal disappears while the temperature of the band is lower than the temperature of the predetermined reference value (OFF).

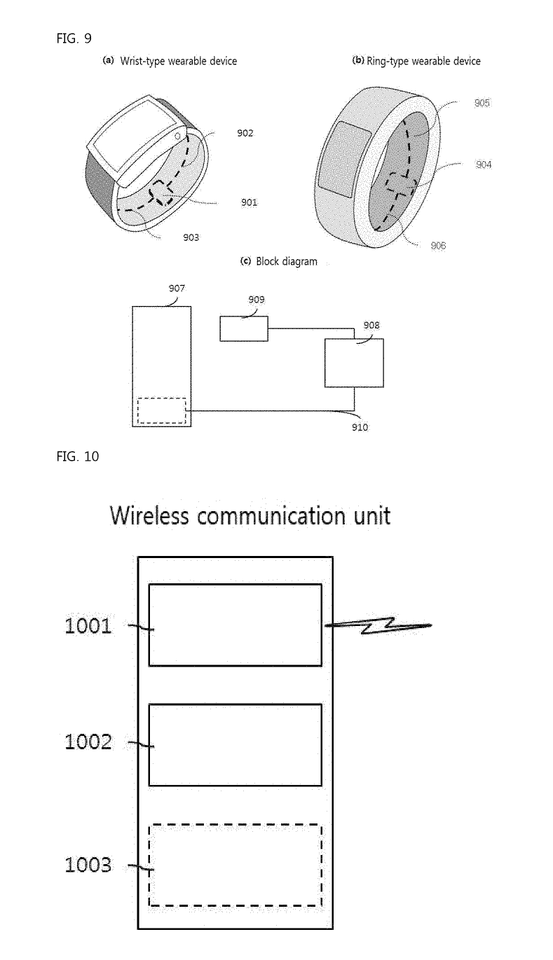

FIG. 9 illustrates an example of a wearing sensing unit configured by a proximity sensor of the hand-attached wearable device with a drawing according to an embodiment of the present invention.

As illustrated in FIG. 9, when the user wears the hand-attached wearable device, proximity sensors 901, 904, and 908 senses wearing of the hand-attached wearable device to generate the signal (ON), while when the user takes off the hand-attached wearable device, the signal disappears (OFF).

In this case, when all of the connection lines of the respective sensors are configured in one band, since it may be sensed that the user wears the hand-attached wearable device similarly even though the other band is cut or the user wears the hand-attached wearable device, it may be accurately determined whether the user wears the hand-attached wearable device even when one band is cut or the user does not wear the hand-attached wearable device by particularly connecting lines included in both bands.

Next, a means (hereinafter, referred to as an ‘iris recognition unit’) for the iris recognition by using the iris image of the smart phone in the hand-attached wearing device will be described.

The iris recognition unit is constituted by a means for measuring whether the photographed iris image has a quality suitable for the iris recognition, a preprocessing means for extracting only the iris from the photographed iris image so as to an iris template, and a means for generating the iris template from the iris image.

In the present invention, when the process of the iris recognition is described in detail, a process that evaluates whether the photographed iris image has a quality criterion suitable for the iris recognition (the means for measuring whether the iris image has the quality suitable for the iris recognition), extracts only the iris so as to create the iris template from the evaluated iris image (the preprocessing means, the preprocessing means may be omitted), and creates the iris template from the extracted iris (the means for creating the iris template) is performed. In this case, the quality criterion of the iris image may include autonomous quality evaluation criterion information including clearness, occlusion, and the like of the iris image.

Since a technical configuration that measures the quality of the iris image according to the present invention is disclosed in detail in Patent Registration No. 10-1030652 registered through patent application by the present invention applicant, the technical configuration is not disclosed in the present specification.

As described above, since prior art for the iris recognition is art which has already been known, more detailed description will be omitted.

Next, a means (hereinafter, referred to as a ‘wireless communication unit’) for performing wireless communication with various devices in the hand-attached wearing device will be described.

In order to perform the wireless communication, the wireless communication unit senses the strength of a signal transmitted/received by a device accessing the hand-attached wearable device and verifies whether the device is within a communication distance at which communication may be performed based on the strength of the sensed signal. In this case, a procedure for identifying whether the accessing device is registered in advance is performed through various methods.

FIG. 10 is a block diagram schematically illustrating a wireless communication unit according to an embodiment of the present invention.

As illustrated in FIG. 10, the wireless communication unit is constituted by a means (Hereinafter, referred to as a ‘short-range wireless identification module’) 1001 for communicating with various devices in a short range by using technologies such as Bluetooth, Near Field Communication (NFC), Radio Frequency Identification (RFID), infrared data association (IrDA), Ultra Wideband (UWB), ZigBee, and Beacon and a means (hereinafter, referred to as a ‘session management module’) 1002 for managing a session occurring during communication with various devices.

Further, a means (hereinafter, referred to as a ‘time-space device authentication module’) 1003 for identifying the accessing device by using time information and space information (hereinafter, referred to as ‘time-space information’) of the device, which is generated when the iris recognition and the procedure for verifying the wearable device is worn is additionally configured to performs a process of identifying the device even during the wireless communication. If the time-space device authentication module is not configured, malicious hacking may occur, in which the hand-attached wearable device is connected with a normal device only during the initial communication connection and another additional equipment is used during an intermediate process of performing communication.

In addition, it is possible to additionally configure a means for receiving a TV broadcasting signal, a radio broadcasting signal, and a data broadcasting signal, a means for performing mobile communication, a means for performing wireless Internet such as Wi-Fi and LTE and any component may be used as long as the corresponding component meets the purpose and the gist of the present invention.

Next, the short-range wireless identification module will be described.

The short-range wireless identification module performs short-range wireless communication with various devices (hereinafter, an ‘authentication request device’) requesting authentication for verifying whether the user is a user registered by the iris recognition using a hand-attached wearable device which is registered in advance and a user (hereinafter, a ‘registered wearing user’) actually wearing the hand-attached wearable device a present.

The authentication request device may correspond to various mobile devices such as the smart phone or a tablet, various security devices such as a security camera or a door lock, various transporting means such as a vehicle or an airplane, various medial devices used in a hospital, and the like in addition to a PC or a computer. As short range communication technology used in this case, at least one among Bluetooth, radio frequency identification (RFID), infrared data association (IrDA), ultra wideband (UWB), ZigBee, or the like may be selected and used.

Whether the device accessing the hand-attached wearable device is registered in advance is verified for the short-range wireless communication by using identification information including a unique number, an MAC address, a personal identification number (Pin) code, and the like.

In addition to the aforementioned identification information, the verification may be performed by using a public key based electronic signature authentication, an encoding authentication, an authentication using various proximity sensors, an authentication using a code such as a QR code, an authentication using an NFC chip or an RFID chip, a user identification module (UIM), a subscriber identity module (SIM), a universal user identity module (USIM), a smart card, and the like.

In recent years, a technique called pairing has been widely used for mutual secure wireless communication, and the verification may be performed by inputting the PIN code or automatically performing the pairing technique.

In the present invention, any technique may be used as long as the corresponding technique consistent with the purpose and the gist of the present invention, which performs the short-range wireless communication with the authentication request device and identifies whether the device is the registered device, and since the prior art for various short-range wireless communications including the pairing technique is the art which has already been known, a more detailed description thereof will be omitted.

Next, the session management module will be described.

The hand-attached wearable device worn by the user manages all communication-related sessions with the outside (device or network), and particularly when the token or key generated and transferred from the authentication request device is transmitted, the time is compared with each other and when it is determined that the time is more than a predetermined time, the session may stop.

Further, by using absolute positional information using GPS information or relative positional information using a base station or a wireless AP connected with the terminal, when it is determined that the hand-attached wearing device deviates from a predetermined position, the session may stop.

After the hand-attached wearable device verifies that the user is the registered wearing user of the hand-attached wearable device at the request of the authentication requesting device, the session which occurs after the authorization of the resource access of the authentication requesting device is approved is distinguished from the existing session and the corresponding session is defined and described as a ‘secure communication session’.

While the secure communication session is performed, a completion state of the registered wearer verification is maintained between the wearable device and the authentication request device without performing additional registered wearing user verification, even if there is a request to request additional registered wearing user verification and the secure communication session is immediately terminated immediately when a registered wear user entitlement is released or a request for secure communication session reset is received.

The entitlement release of the registered wearing user occurs when the user releases the wearing of the hand-attached wearable device or when mutual identification is impossible due to movement of the wearable device or the authentication request device or when an effective time of the iris image information has elapsed. In addition, the request for the secure communication session reset is executed when the number of secure communication session connection attempts is more than a predetermined criterion.

The expiration date of the iris image information means previously setting a usable time of the iris image information based on a time when the token is generated in order to request authenticating the registered wearing user from the authentication request device or a time when the hand-attached wearable device photographs the iris image.

If the number of connection attempts is not set when the secure communication session connection is not normally performed, the connection attempt may be made infinitely when the communication session is actually disconnected, and as a result, there is a risk in security. Therefore, only the minimum connection attempt as possible is permitted.

Next, a time-space device authentication module will be described.

The time-space device authentication module stores the time-space information of the hand-attached wearable device and identifies the authentication request device by receiving time information in which the authentication request device requests the hand-attached wearable device to photograph the iris image, location information of the authentication request device which requests the hand-attached wearable device to photograph the iris image, time information in which the authentication request device requests the hand-attached wearable device to senses wearing or location information of the authentication request device at the time of sensing wearing (hereinafter, referred to as ‘time-space information of authentication request device’). In this case, location information of the space-time information may be relative location information using the unique number of the base station or wireless AP to which the hand-attached wearable device is connected or absolute location information using GPS information.

The time-space information of the hand-attached wearable device may be iris image photographing time information of the hand-attached wearable device, location information of the hand-attached wearable device at the time of photographing the iris image, wearing sensing time information of the hand-attached wearable device, or location information of the hand-attached wearable device at the time of sensing the wearing. In this case, location information of the space-time information may be relative location information using the unique number of the base station or wireless AP to which the hand-attached wearable device is connected or absolute location information using GPS information.

Identification of the device using the time-space information may be executed whenever it is verified that the user is the registered wearing user and executed only at a specific time such as the time when the iris image information is acquired or the time when the user release the wearing.

Next, a security reinforcing unit that encodes the iris image information transferred through the wireless communication in the hand-attached wearable device will be described.

The iris encoding module 2101 inserts a token or a key created and transferred from the IoT device into the iris image information to encode the iris image information.

In particular, a digital watermark is particularly inserted into the iris image information against a case that the iris image information is attempted to be fabricated during mutual transmission/reception. In this case, it is preferable that the process of inserting the digital watermark is protected from external intrusion in terms of hardware so as to prevent the insertion process from being leaked.

Further, during mutual transmission and reception, at least one of the unique number, a Pin code, and one time password (OTP) is selected and encoded. In this case, when the iris encoding module encodes the iris image information, the iris encoding module may add and encode at least one of the unique number, the personal identification number, and the OTP of the terminal.

Further, the time-space information of the hand-attached wearable device may be selected and encoded. In this case, location information of the space-time information may be relative location information using the unique number of the base station or wireless AP to which the hand-attached wearable device is connected or absolute location information using GPS information.

Next, a system (hereinafter, referred to as a security reinforcing set) which is constituted by the hand-attached wearable device and the authentication request device and invented so that a relationship (hereinafter, referred to as a ‘primary authentication relationship’) in which the hand-attached wearable device verifies that the user is the registered wearing user of the hand-attached wearable device at the request of the authentication request device and thereafter, is approved with the resource access authority of the authentication request device is established will be described in detail. The authentication request device which will constitute the security reinforcing set with the hand-attached wearable device may not perform the iris recognition by using the iris image information photographed and acquired by the hand-attached wearable device by using most sensor devices having low computing power or a low-capacity memory and storage device at present.

On the contrary, the authentication request device may be configured by the authentication request device having computer power to perform the iris recognition with the iris image information transferred from the hand-attached wearable device like the smart phone.

Therefore, the case where the authentication request device which will constitute the security reinforcing set with the hand-attached wearable device may not perform the iris recognition and the case where the authentication request device which will constitute the security reinforcing set with the hand-attached wearable device may not perform the iris recognition performs the iris recognition are separately described in detail.

Of course, since the iris recognition may be performed by using one of both devices or the iris recognition may be performed by using both devices when both devices may perform the iris recognition, this case corresponds one of the assumptions and may be thus sufficiently appreciated, and as a result, the detailed description thereof will be omitted.

(A1) Case where Authentication Request Device May not Perform Iris Recognition

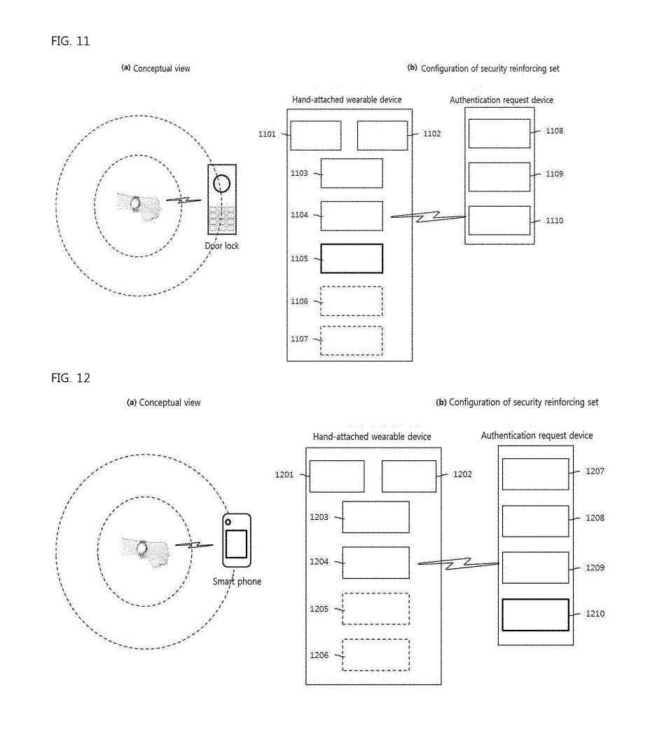

FIG. 11 illustrates an example schematically illustrating a concept and a configuration of a security reinforcing set considering the case where the authentication request may not perform the iris recognition according to an embodiment of the present invention.

As illustrated in the concept view of FIG. 11, when the authentication request device is a normal door lock using the memory or storage device having the low computing power or low capacity, the authentication request device may not perform the iris recognition by using the iris image information acquired by the hand-attached wearable device.

Therefore, the hand-attached wearable device needs to be configured to perform the iris recognition and the authentication request device needs to be configured to establish the primary authentication relationship using the result.

The hand-attached is constituted by a camera 1101 installed on one side of the hand-attached wearable device and photographing the iris image, an infrared lighting 1102 installed on one side of the hand-attached wearable device and lighting the iris image illuminating at the time of photographing the iris image, a wearing sensing unit 1103 sensing whether the hand-attached wearable device is worn on the wrist or finger, a wireless communication unit 1104 transmitting/receiving information to/from the authentication request device, an iris recognition unit 1103 comparing the registered iris image information and the photographed iris image information, a security reinforcing unit 1106 encoding the iris image information transmitted through the wireless communication, and a display 1107.

The authentication request device includes a short range wireless communication unit 1110 performing short range wireless communication with the hand-attached wearable device, a token management unit 1109 generating and destroying tokens to be transmitted to the hand-attached wearable device, and a decoding unit 1108 decoding the encoded information received from the hand-attached wearable device.

(A1) Case where Authentication Request Device Performs Iris Recognition

FIG. 12 illustrates an example schematically illustrating the concept and the configuration of the security reinforcing set considering the case where the authentication request device performs the iris recognition according to the embodiment of the present invention.

As illustrated in the concept view of FIG. 12, when the authentication request device is the smart phone in which a component having computing power to perform the iris recognition with the iris image information transferred from the hand-attached wearable device may be installed, the authentication request device may sufficiently perform the iris recognition.

Therefore, the hand-attached wearable device needs to be configured to transfer the iris image information by the wireless communication and the authentication request device needs to be configured to establish the primary authentication relationship by performing the iris recognition with the iris image information transferred from the hand-attached wearable device.

The hand-attached is constituted by a camera 1201 installed on one side of the hand-attached wearable device and photographing the iris image, an infrared lighting 1202 installed on one side of the hand-attached wearable device and lighting the iris image illuminating at the time of photographing the iris image, a wearing sensing unit 1203 sensing whether the hand-attached wearable device is worn on the wrist or finger, a wireless communication unit 1204 transmitting the iris image information to the device, a security reinforcing unit 1205 encoding the iris image information transmitted through the wireless communication, and a display 1206.

The authentication request device includes a short range wireless communication unit 1209 performing short range wireless communication with the hand-attached wearable device, a token management unit 1208 generating and destroying tokens to be transmitted to the hand-attached wearable device, a decoding unit 1207 decoding the encoded information received from the hand-attached wearable device, and an iris matching unit 1210 comparing the iris image information transmitted from the hand-attached wearable device and the registered and stored iris image information.

Since the hand-attached wearable device constituting the security reinforcing set has already been described above in detail, the description thereof will be omitted. Next, the configuration of the authentication request device of the security reinforcing set described above will be described in detail.

As illustrated in FIGS. 11 and 12, the authentication request device is fundamentally constituted by short range wireless communication units 1110 and 1209 which may perform the wireless communication with the hand-attached wearable device. The short range wireless communication unit is constituted by a wireless identification module that transmits the identification information of the authentication request device or the time-space information of the authentication request device and identifies whether the hand-attached wearable device is a registered device and a session control module that controls a session generated while performing the short range wireless communication with the hand-attached wearable device.

FIG. 13 is a block diagram schematically illustrating a configuration of a short range wireless communication unit according to an embodiment of the present invention. The short-range wireless communication unit has the same configuration as the short-range wireless identification module of the hand-attached wearable device.

As illustrated in FIG. 13, a wireless identification module 1302 may perform identification through mutual authentication when connecting or pairing with the authentication request device and perform authentication between devices which are registered in advance by primarily inputting the Pin code, using various proximity sensors, or using an NFC chip or a specific code such as the QR code. Further, an identification module capable of distinguishing the device may be provided or an authentication such as an electronic signature using a public key may be used.

In order to identify the device, the identification information of the device, such as the unique number of the device, the MAC address, the Pin code, and the like described in the wireless communication unit of the hand-attached wearable device may be used as it is, however, various methods may be selected, such as identifying the device by using the time-space information of the hand-attached wearable device or the authentication request device, which is generated during actual identification.

The time-space information of the authentication request device includes at least one of time information in which the authentication request device requests the hand-attached wearable device to photograph the iris image, location information of the authentication request device at the time of requesting photographing the iris image to the hand-attached wearable device, time information in which the authentication request device requests the hand-attached wearable device to sense wearing, and location information of the authentication request device when the wearing sensing is requested. Since more detailed contents are described in detail, in the short-range wireless identification module of the hand-attached wearable device, the more detailed description will be omitted.

The session control module 1301 maintains the registered wearing user verification completed without requesting additional registered wearing user verification while the secure communication session is being performed and stops the secure communication session immediately when the registered wearing user entitlement is released or a request for resetting the secure communication session is received.

The session control module also has the same configuration as the session management module of the hand-attached wearable device.

The entitlement release of the registered wearing user occurs when the user releases the wearing of the hand-attached wearable device or when mutual identification is impossible due to movement of the wearable device or the authentication request device or when an effective time of the iris image information has elapsed. In addition, the request for the secure communication session reset is executed when the number of secure communication session connection attempts is more than a predetermined criterion.

Since more detailed contents are described in detail, in the session management module of the hand-attached wearable device, the more detailed description will be omitted.

In the case of the token management units 1109 and 1208, a token management unit mounted on the authentication request device selects at least one of the unique number, the Pin code, the one time password (OTP), and the random number of the authentication request device to configure the token or key in order to request verifying the wearing user registered in the hand-attached wearable device.

The token management units 1109 and 1208 may transmit the generated token or key to the hand-attached wearable device and in this case, additionally transmit the time-space information of the authentication request device.

Further, when the iris image information is received from the hand-attached wearable device, it may be determined whether the iris image information is damaged by using the token or key sent in advance.

The decoding units 1108 and 1207 decode the encoded information transmitted through the hand-attached wearable device, in particular, the security reinforcing unit. The decoding unit is primarily configured by software and configured by a decoding program designed and prepared by using a normal decoding algorithm.

Since prior art related therewith is already known art, a more detailed description thereof will be omitted.

The iris matching unit 1210 is configured to decrypt the encoded iris image information transmitted from the hand-attached wearable device in the decoding unit and compares the similarity with the decrypted iris image information and the iris image information of the iris matching unit registered in advance to authenticate the corresponding user when the similarity is within a set range.

Since the iris matching unit also has the same configuration as the iris recognition unit of the hand-attached wearable device and contents related therewith are described in the iris recognition unit, the more detailed description will be omitted.

The token manager, the decoding unit, and the iris matching unit of the authentication request device are generally constituted by software and may be constituted to be automatically installed in a memory of the authentication request device.

Further, the software according to the present invention may be installed by an application or a program which may be downloaded from a server.

Next, a technical configuration of registering iris image information in the hand-attached wearable device and the authentication request device according to the present invention described above will be described in detail.

In the case where there is no data matched with iris image information formed from the iris imaged picked-up from the camera of the hand-attached wearable device, iris image information of a new user is registered and stored in a database or a memory of the iris recognition unit of the hand-attached wearable device and the iris recognition unit of the authentication request device and new registration ends. Of course, the iris image information used in new registration or additional registration may be registered and stored by using information stored in the memory or the database in advance and an unnecessary person may be deleted from persons registered and stored in the database or the memory.

Because the related art thereof is widely known, the detailed description will be omitted.

Next, in the security reinforcing set constituted by the hand-attached wearable device and the authentication request device according to the present invention, a method of establishing a primary authentication relationship of receiving a resource access authority of the authentication request device by the hand-attached wearable device, after the user verifies the registered wearing user of the hand-attached wearable device by a request of the authentication request device will be described in detail.

In wireless communication, it is very important to establish secure communication considering security between the devices.

To this end, as described above, a technique of performing authentication between pre-registered devices by inputting a Pin code, using various proximity sensors, or using an NFC chip or a specific code such as a QR code has been applied.

Further, various techniques such as providing a device identification module or using authentication such as an electronic signature using a public key have been used in the related art.

However, there is a disadvantage in that the conventional techniques and methods perform security in communication between the devices, but may not perform authentication for the device using the same.

Further, whether the user uses a device performing communication in real time may be verified.

Further, in most of devices, like sensor devices, computer power is low or it is almost impossible to apply the iris recognition for security reinforcement by using low-capacity memory and storage device.

Accordingly, in the security reinforcing set constituted by the hand-attached wearable device and the authentication request device, the disadvantages may be overcome by verifying the registered wearing user verification through three authentication steps.

First, a process (hereinafter, referred to as ‘device authentication’) of verifying whether the hand-attached wearing device and the authentication request device connected by the wireless communication are devices which are registered in each other is performed, second, a process user (hereinafter, referred to as ‘user authentication’) of verifying whether the user is a registered wearing user by comparing the iris image information registered and stored through the iris recognition and the photographed iris image information is performed, and last, a process (hereinafter, referred to as ‘wearing authentication’) of verifying whether the user wears the hand-attached wearing device is performed to finally complete verifying that the user is the registered wearing user.

The device authentication is performed while verifying whether the hand-attached wearable device and the authentication request device are devices which are registered in each other in a short range identification module or a time-space device authentication module of the wireless communication unit of the hand-attached wearable device and a wireless identification module of the authentication request device.

The user authentication is performed by comparing the iris image information registered and stored in the iris recognition unit of the hand-attached wearable device or the iris matching unit of the authentication request device and the photographed iris image information.

The wearing authentication is performed while verifying whether the user actually wears the hand-attached wearable device by the wearing sensing unit of the hand-attached wearable device.

Three authentication steps given above may be performed regardless of the order according to the configuration of the security reinforcing set and a use habit or method of the device. For example, first, after the user wears the hand-attached wearable device performing the user authentication, the device authentication with the authentication request device may be performed, and on the other hand, the hand-attached wearable device performing the device authentication with the authentication request device is worn and the user authentication may be performed.

Accordingly, when the user approaches the authentication request device while wearing the hand-attached wearable device which is the most frequently occurring case in the present invention and performs iris recognition when the authentication is requested from the authentication request device and selects sensing the wearing as an example, and another case may be also sufficiently understood except for a difference in only order from the case, and thus the detailed description will be omitted.

(B1) Case where the Authentication Request Device Cannot Perform Iris Recognition

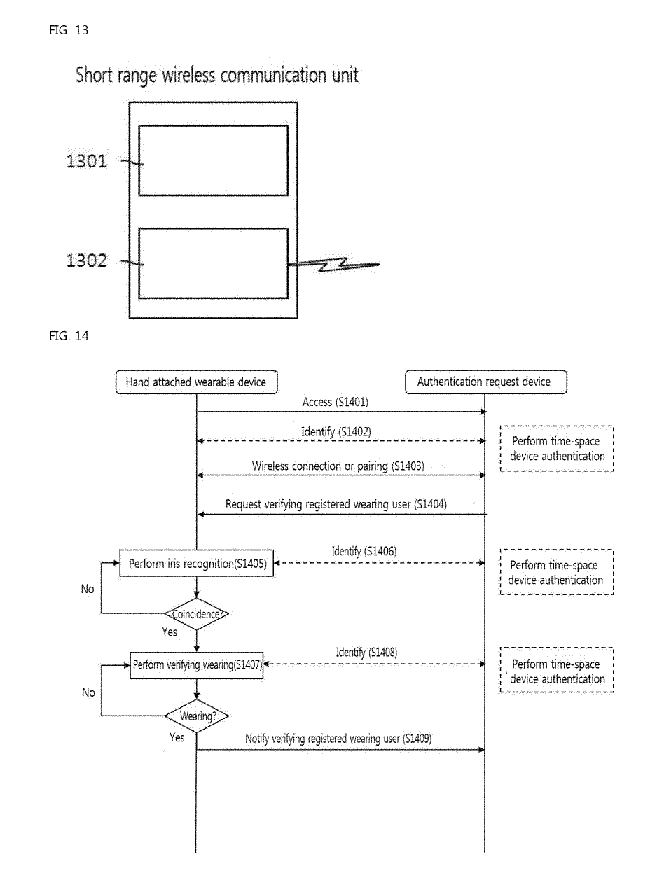

FIG. 14 is a flowchart for describing a method of completing registered wearing user verification in a security reinforcing set which considers a case where the authentication request device according to the embodiment of the present invention cannot perform iris recognition.

As illustrated in FIG. 14, first, the method is constituted by accessing a hand-attached wearable device to the authentication request device (S1401), identifying whether a wireless communication unit of the hand-attached wearable device and a short-range wireless communication unit of the authentication request device are registered devices, respectively, in a step where the short-range wireless communication unit of the authentication request device connects or pairs the short-range wireless communication with the wireless communication unit of the hand-attached wearable device when the hand-attached wearable device accessing the authentication request device approaches within a communicable distance by sensing intensity of a transmitted/received signal (device authentication) (S1402), connecting or pairing, by the short-range wireless communication unit of the authentication request device, the short-range wireless communication with the wireless communication unit of the hand-attached wearable device when the hand-attached wearable device accessing the authentication request device approaches within a communicable distance by sensing intensity of a transmitted/received signal (S1403), requesting registered wearing user verification to be performed from the hand-attached wearable device by transmitting a token or a key requesting registered wearing user verification generated from a token manager of the authentication request device to the hand-attached wearable device (S1404), performing user authentication verifying whether the user is the registered wearing user by transferring iris image information generated from an iris image picked-up by a camera of the hand-attached wearable device to the iris recognition unit in order to verify the registered wearing user in the hand-attached wearable device and comparing the transferred iris image information with iris image information registered and stored in the iris recognition unit (user authentication) (S1405), identifying the device by using time-space information generated when performing the iris recognition (S1406), verifying whether the user wears the hand-attached wearable device by the wearing sensing unit of the hand-attached wearable device (wearing authentication) (S1407), identifying the device by using time-space information generated when verifying whether wearing sensing is present (S1408), and receiving authorization of the resource access of the authentication request device after the hand-attached wearable device completes registered wearing user verification and notifies the completed verification to the authentication request device (S1409).

In FIG. 14, steps S1401 to S1409 are sequentially performed, but the technical spirit of the embodiment of the present invention is just described, and without departing from the intrinsic features of an embodiment of the present invention, those skilled in the art which belongs to the embodiment of the present invention change or execute the order illustrated in FIG. 14 or execute one or more of steps S1401 to S1409 in parallel and thus various modifications and variations will be applicable, and FIG. 14 is not limited to a time serial order.

(B2) a Case where the Authentication Request Device Performs Iris Recognition

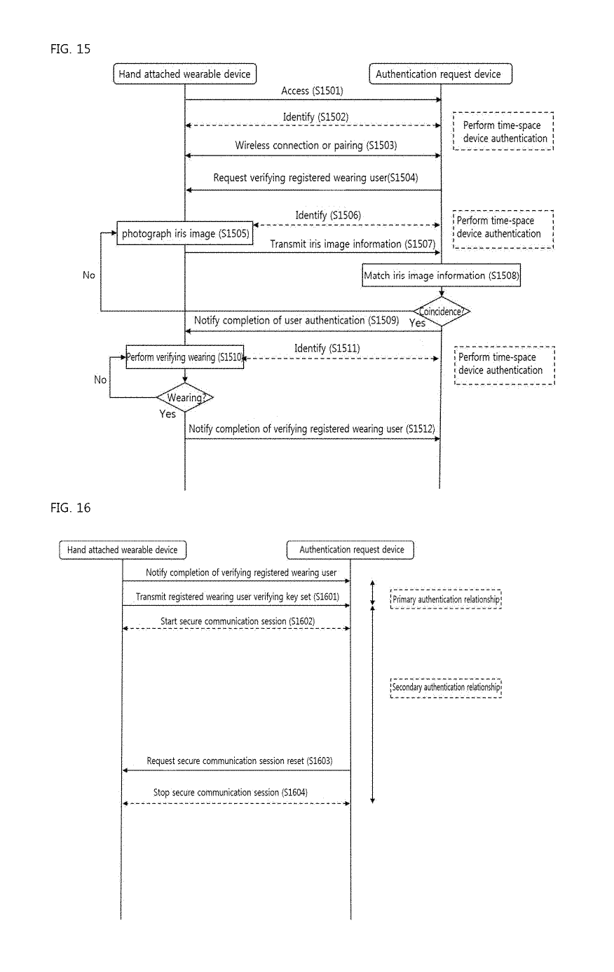

FIG. 15 is a flowchart for describing a method of completing registered wearing user verification in a security reinforcing set which considers a case where the authentication request device according to the embodiment of the present invention performs iris recognition.

As illustrated in FIG. 15, first, the method is constituted by the steps of accessing a hand-attached wearable device to the authentication request device (S1501), identifying whether a wireless communication unit of the hand-attached wearable device and a short-range wireless communication unit of the authentication request device are registered devices, respectively, in a step where the short-range wireless communication unit of the authentication request device connects or pairs the short-range wireless communication with the wireless communication unit of the hand-attached wearable device when the hand-attached wearable device accessing the authentication request device approaches within a communicable distance by sensing intensity of a transmitted/received signal (device authentication) (S1502), connecting or pairing, by the short-range wireless communication unit of the authentication request device, the short-range wireless communication with the wireless communication unit of the hand-attached wearable device when the hand-attached wearable device accessing the authentication request device approaches within a communicable distance by sensing intensity of a transmitted/received signal (S1503), requesting registered wearing user verification to be performed from the hand-attached wearable device by transmitting a token or a key requesting registered wearing user verification generated from a token manager of the authentication request device to the hand-attached wearable device (S1504), acquiring an iris image of the user by using a camera of the hand-attached wearable device for verifying the registered wearing user (S1505), identifying the device by using time-space information generated when requesting the iris recognition (S1506), encoding the iris image information acquired from the hand-attached wearable device to transfer the encoded iris image information to the short-range wireless communication unit of the authentication request device (S1507), decoding the received encoded iris image information by a decoding unit of the authentication request device and matching the transmitted iris image information and the registered iris image information to an iris matching unit (user authentication) (S1508), notifying, to the hand-attached wearable device, that the user authentication is completed, by the short-range wireless communication unit of the authentication request device (S1509), verifying whether the user wears the hand-attached wearable device by the wearing sensing unit of the hand-attached wearable device (wearing authentication) (S1510), identifying the device by using time-space information generated when verifying whether wearing sensing is present (S1511), and receiving authorization of the resource access of the authentication request device after the hand-attached wearable device completes registered wearing user verification and notifies the completed verification to the authentication request device (S1512).

In FIG. 15, steps S1501 to S1512 are sequentially performed, but the technical spirit of the embodiment of the present invention is just described, and without departing from the intrinsic features of an embodiment of the present invention, those skilled in the art which belongs to the embodiment of the present invention change or execute the order illustrated in FIG. 15 or execute one or more of steps S1501 to S1512 in parallel and thus various modifications and variations will be applicable, and FIG. 15 is not limited to a time serial order.

Next, in the security reinforcing set constituted by the hand-attached wearable device according to the present invention and the authentication request device, after establishing the step (primary authentication relationship) of receiving authorization of the resource access of the authentication request device after the hand-attached wearable device completes registered wearing user verification and notifies the completed verification to the authentication request device, in order to maintain the primary authentication relationship, a method of establishing a relationship (hereinafter, referred to as ‘secondary authentication relationship’) of a secure inter-communication session after transmitting a registered wearing user verification key to the authentication request device will be described in detail.

In the security reinforcing set constituted by the hand-attached wearable device and the authentication request device, in order to establish the inter-secondary authentication relationship, first, the above-described primary authentication relationship needs to be established.

That is, after verifying the registered wearing user of the hand-attached wearable device and then receiving the authorization of the resource access of the authentication request device, in order to maintain the secure communication session, a registered wearing user verification key set is transmitted.

The registered wearing user verification key set is constituted by one or more tokens or keys notifying a condition in which the device authentication, the user authentication, and the wearing authentication are completed and the primary authentication relationship is continued and may be constituted by adding time-space information, iris image information, device identification information, and the like generated during the device authentication, the user authentication, and the wearing authentication.

While the secure communication session is performed, even though a request for verifying an additional registered wearing user is required, between the hand-attached wearable device and the authentication request device, the verification of the additional registered wearing user is not performed and a state in which the verification of the additional registered wearing user is completed is maintained.

Further, when mutual identification is impossible due to released or movement of the hand-attached wearable device or the authentication request device, or unsetting of the registered wearing user executed when the valid time of the iris image information has elapsed or a request for resetting the secure communication session executed when a secure communication session connection attempt exceeds a predetermined reference occurs, the secure communication session is immediately interrupted.

FIG. 16 is a flowchart for describing a method of establishing a secondary authentication relationship after establishing the primary authentication relationship according to an embodiment of the present invention.

As illustrated in FIG. 16, the method is constituted by the steps of first, transmitting a user verification key set to a short-range wireless communication unit of the authentication request device from the wireless communication unit of the hand-attached wearable device under a condition in which the primary authentication relationship is mutually established after the hand-attached wearable device notifies completion of the registered wearing user verification to the authentication request device (S1601), starting a mutual secure communication session by the wireless communication unit of the hand-attached wearable device and the short-range wireless communication unit of the authentication request device (S1602), requesting resetting of the registered wearing user verification or resetting of the secure communication session (S1603), and interrupting the mutual secure communication session by the wireless communication unit of the hand-attached wearable device and the short-range wireless communication unit of the authentication request device by requesting release of the secure communication session (S1604).

In FIG. 16, steps S1601 to S1604 are sequentially performed, but the technical spirit of the embodiment of the present invention is just described, and without departing from the intrinsic features of an embodiment of the present invention, those skilled in the art which belongs to the embodiment of the present invention change or execute the order illustrated in FIG. 16 or execute one or more of steps S1601 to S1604 in parallel and thus various modifications and variations will be applicable, and FIG. 16 is not limited to a time serial order.

The steps may be performed regardless of the order according to the configuration of the security reinforcing set and a usage habit or method of the smart phone. For example, first, after the user wears the hand-attached wearable device performing the user authentication, the device authentication with the authentication request device may be performed, and on the other hand, the hand-attached wearable device performing the device authentication with the authentication request device is worn and the user authentication may be performed.

Accordingly, when the user approaches the authentication request device while wearing the hand-attached wearable device which is the most frequently occurring case in the present invention and performs iris recognition when the authentication is requested and selects sensing the wearing, and another case may be also sufficiently understood except for a difference in only order from the case, and thus the detailed description will be omitted.

Next, in an environment where a plurality of authentication request devices is present, when there is a device (hereinafter, referred to as ‘a second authentication request device’) requesting authentication to the authentication request device (hereinafter, referred to as ‘a first authentication request device’) within a distance which is wireless-communicable with the hand-attached wearable device, an execution method of the security reinforcing set constituted by the hand-attached wearable device and the authentication request device according to whether the secure communication session is performed will be described in detail.

Actually, using the smart phone as a card performing payment in the banks or merchandise stores has been recently increased, but problems such as receiving authentication of the smart phone whenever performing access or payment of an unauthorized smart phone due to a loss are not yet solved. Further, recently, in an internet of things (IoT) which has been issued, application for a technique of opening and closing the door or controlling electronic device of the home network by using the smart phone as an authentication key of a vehicle or a home network is rapidly proceeding.

Accordingly, when an access of an unauthorized user is prevented in the authentication request device (the first authentication request device) by performing the iris recognition in the hand-attached wearable device and the payment is performed by short-range wireless communication with the device (the second authentication request device) requesting the payment to the first authentication request device, the problems may be sufficiently solved.

(C1) Case where the First Authentication Request Device Cannot Perform Iris Recognition

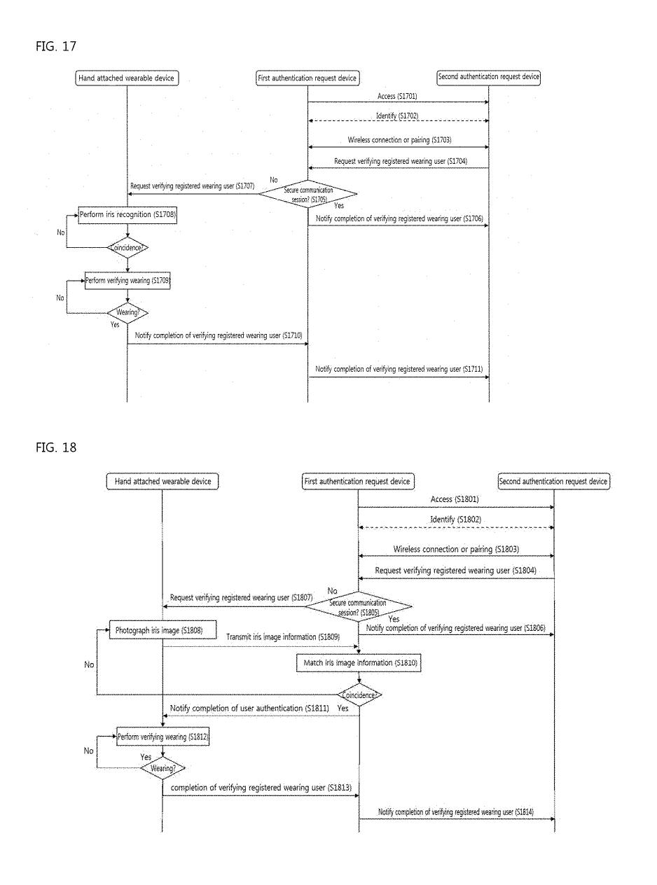

FIG. 17 is a flowchart for describing a method of completing registered wearing user verification in a security reinforcing set which considers a case where the authentication request device cannot perform iris recognition according to whether the secure communication session according to the embodiment of the present invention is performed (the secondary authentication relationship is established).

As illustrated in FIG. 17, the method is constituted by the steps of first, accessing a second authentication request device by the first authentication request device (S1701), sensing intensity of a transmitted/received signal of the first accessed first authentication request device and identifying the first authentication request device within a communication distance which is communicable based on the intensity of the sensed signal (device authentication) (S1702), performing mutual wireless connection or pairing (S1703), requesting registered wearing user verification to the first authentication request device after performing the mutual wireless connection or pairing (S1704), verifying whether the first authentication request device and the hand-attached wearable device maintains the secure communication session (establishes a secondary authentication relationship) (S1705), notifying immediately completion of the registered wearing user verification to a second authentication request device (S1706), requesting the registered wearing user verification to the hand-attached wearable device if the secure communication session is not maintained (S1707), first performing iris recognition by using iris image information of a smart phone for the registered wearing user verification (user authentication) (S1708), verifying whether the user wears the hand-attached wearable device for the registered wearing user verification (wearing authentication) (S1709), establishing a primary authentication relationship by completing the registered wearing user verification and notifying the completed verification to the first authentication request device (S1710), and transferring, by the first authentication request device, notification of the completion of the registered wearing user verification received from the hand-attached wearable device to the second authentication request device (S1711).

In FIG. 17, steps S1701 to S1711 are sequentially performed, but the technical spirit of the embodiment of the present invention is just described, and without departing from the intrinsic features of an embodiment of the present invention, those skilled in the art which belongs to the embodiment of the present invention change or execute the order illustrated in FIG. 17 or execute one or more of steps S1701 to S1711 in parallel and thus various modifications and variations will be applicable, and FIG. 17 is not limited to a time serial order.

Further, the method may be further constituted by the steps of identifying the device by using time-space information generated when performing the iris recognition and identifying the device by using the time-space information generated when verifying whether wearing sensing is present.

(C2) Case where the Second Authentication Request Device Performs Iris Recognition

FIG. 18 is a flowchart for describing a method of completing registered wearing user verification in a security reinforcing set which considers a case where the authentication request device performs iris recognition according to whether the secure communication session according to the embodiment of the present invention is performed (the secondary authentication relationship is established).

As illustrated in FIG. 18, the method is constituted by the steps of first, accessing the second authentication request device by the first authentication request device (S1801), sensing intensity of a transmitted/received signal of the first accessed first authentication request device and identifying the first authentication request device within a communication distance which is communicable based on the intensity of the sensed signal (device authentication) (S1802), performing mutual wireless connection or pairing (S1803), requesting registered wearing user verification to the first authentication request device after performing the mutual wireless connection or pairing (S1804), verifying whether the first authentication request device and the hand-attached wearable device maintains the secure communication session (establishes a secondary authentication relationship) (S1805), notifying immediately completion of the registered wearing user verification to a second authentication request device (S1806), requesting the registered wearing user verification to the hand-attached wearable device if the secure communication session is not maintained (S1807), acquiring iris image information of a smart phone for the registered wearing user verification by using a camera of the hand-attached wearable device (S1808), transmitting, by the hand-attached wearable device, the iris image information to the first authentication request device (S1809), matching registered iris image information with the transferred iris image information (user authentication) (S1810), notifying, to the hand-attached wearable device, that the user authentication is completed (S1811), verifying whether the user wears the hand-attached wearable device for the registered wearing user verification (wearing authentication) (S1812), establishing a primary authentication relationship by completing the registered wearing user verification and notifying the completed verification to the first authentication request device (S1813), and transferring, by the first authentication request device, notification of the completion of the registered wearing user verification received from the hand-attached wearable device to the second authentication request device (S1814).

In FIG. 18, steps S1801 to S1814 are sequentially performed, but the technical spirit of the embodiment of the present invention is just described, and without departing from the intrinsic features of an embodiment of the present invention, those skilled in the art which belongs to the embodiment of the present invention change or execute the order illustrated in FIG. 18 or execute one or more of steps S1801 to S1814 in parallel and thus various modifications and variations will be applicable, and FIG. 18 is not limited to a time serial order.

Further, the method may be further constituted by the steps of identifying the device by using time-space information generated when performing the iris recognition and identifying the device by using the time-space information generated when verifying whether wearing sensing is present.

Next, a detailed application example of the security reinforcing set constituted by the hand-attached wearable device to the authentication request device according to the present invention described above will be described in detail.

FIG. 19 illustrates a concept of establishing and applying a primary authentication relationship between the hand-attached wearable device and a plurality of authentication request devices according to an embodiment of the present invention.

When the hand-attached wearable device of the smart phone enters within a distance which may use wireless short-range communication of a smart phone or a vehicle (an authentication request device), the smart phone or the vehicle identifies that the hand-attached wearable device is registered in the smart phone or the vehicle by the above-described configuration and then is connected or paired with mutual wireless short-range communication in the case of the registered hand-attached wearable device. In this case, the hand-attached wearable device identifies that the smart phone or the vehicle is registered by the above-described configuration (device authentication).

The smart phone or the vehicle connected with mutual wireless short-range communication requests registered wearing user verification to the hand-attached wearable device.

The hand-attached wearable device receiving the registered wearing user verification picks-up the iris image and performs iris recognition when the iris recognition unit capable of performing the iris recognition is present to verify the registered smart phone (user authentication). If the iris recognition unit capable of performing the iris recognition is not present and an iris matching unit is constituted in the smart phone or the vehicle, the hand-attached wearable device transmits the iris image information to the smart phone or the vehicle and then verifies the registered smart phone in the iris matching unit (user authentication).

After or before performing the iris recognition, whether the user wears the hand-attached wearable device is verified through the wearing sensing unit (wearing authentication).

If the registered smart phone is verified through the iris recognition and whether to wear the hand-attached wearable device is verified (completion of registered wearing user verification), the hand-attached wearable device notifies completion of the registered wearing user verification to the smart phone or the vehicle (establishing of primary authentication relationship).

The established primary authentication relationship after notifying the registered wearing user verification is released and the registered wearing user verification may be requested from the beginning again, but in most cases, for a predetermined time, maintaining a state where the registered wearing user verification is completed is efficient in terms of user convenience as compared with requesting every time if necessary. For example, it is very uncomfortable when a procedure of performing the registered wearing user verification for releasing unlock of the smart phone and then requesting the unlock is repeated, or a procedure of performing the registered wearing user verification when the user closes the vehicle door and gets off for parking and then another person opens the vehicle car again for parking is repeated. Accordingly, the hand-attached wearable device transmits the registered wearing user verification key set to maintain the secure communication session for a predetermined time (establishing of secondary authentication relationship) and thus the inconvenience may be solved.

Further, when the user releases the wearing of the hand-attached wearable device or maintaining of the device authentication is impossible due to movement of the hand-attached wearable device or the smart phone or vehicle, or unsetting of the registered wearing user executed when the valid time of the iris image information has elapsed or a request for resetting the secure communication session executed when a secure communication session connection attempt exceeds a predetermined reference occurs, the secure communication session is immediately interrupted, and the smart phone needs to perform the registered wearing user verification procedure again.

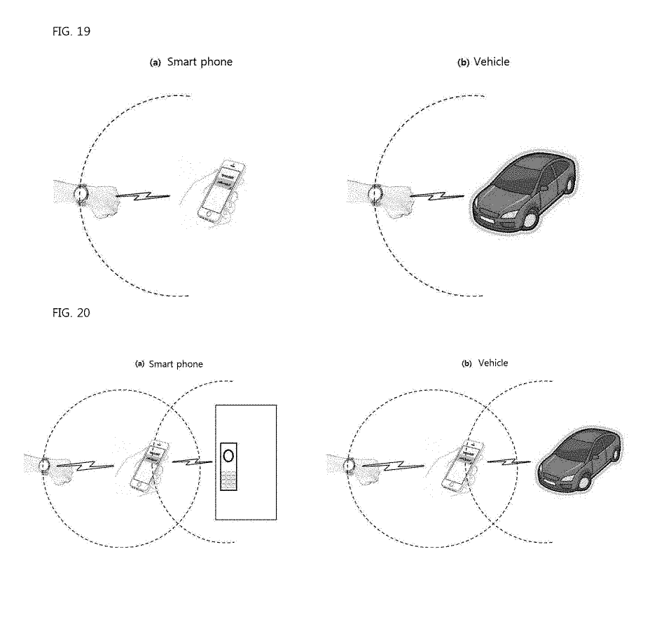

FIG. 20 illustrates a concept of establishing and applying a secondary authentication relationship between the hand-attached wearable device and a plurality of authentication request devices according to an embodiment of the present invention.

In a system of performing payment in conventional smart phone-based banks or merchandise stores or a system capable of intelligent communication such as a vehicle, research and technology development using iris recognition that can enhance security while enhancing convenience of the smart phone is rapidly increased, but is not yet implemented in detail due to many limitations of the smart phone as described above.

As illustrated in FIG. 20, when the hand-attached wearable device is applied to the conventional system using the smart phone, the problems may be easily overcome.

First, when a smart phone (the first authentication request device) enters within a distance which may use wireless short-range communication of a door lock or vehicle (the second authentication request device), the door lock or vehicle identifies that the smart phone is registered in the door lock or vehicle by the above described configuration and then connected or paired with the mutual wireless short-range communication in the case of the registered smart phone. In this case, the smart phone identifies that the door lock or vehicle is registered by the above-described configuration (device authentication).

The door lock or vehicle connected with mutual wireless short-range communication requests the registered wearing user verification to the smart phone.

The smart phone receiving the registered wearing user verification verifies a current secure communication session (establishing of the secondary authentication relationship) with the hand-attached wearable device and notifies that the registered wearing user verification is completed immediately during the secure communication session.

Accordingly, since performance for the registered wearing user verification is not requested to the hand-attached wearable device whenever the door lock or vehicle requests the registered wearing user verification in the secure communication session, convenience of the smart phone may be increased.

When the smart phone is not in the current secure communication session with the hand-attached wearable device, the smart phone requests the registered wearing user verification to the hand-attached wearable device.

The hand-attached wearable device performs the registered wearing user verification by the same method described in FIG. 19, notifies, to the smart phone, that the registered wearing user verification is completed, and the received smart phone notifies, to the door lock or vehicle, that the registered wearing user verification is completed.

Transmission and reception are basically performed through encoding or/and decoding between the hand-attached wearable device and the authentication request device and encoding and decoding in the wireless communication process of the hand-attached wearable device and the authentication request device may install an encoding or decoding program designed by using a general encoding or decoding algorithm.

In this case, all of memories including a RAM, a ROM, a flash, and the like, a type and a specification of the CPU, existence or not and a specification of a communication module, existence or not, and a type and a version of an OS, installed software, and a UI which coincide with the purpose and the gist of the present invention to be described below may be used.

### INDUSTRIAL APPLICABILITY

The present invention relates to a wearing-sensing hand-attached wearable device for iris recognition, a security reinforcing set using the same, and a method for controlling the same, and particularly, a security reinforcing set using a wearing-sensing hand-attached wearable device for iris recognition, including: a wearing-sensing hand-attached wearable device for iris recognition including a camera installed on one side of the hand-attached wearable device and photographing an iris image, an infrared lighting for lighting at the time of photographing the iris image, which is installed on one side of the hand-attached wearable device, a wireless communication unit transmitting and receiving the iris image information photographed and acquired by the camera, and a wearing sensing unit sensing whether the hand-attached wearable device is worn on a wrist or finger or an iris recognition unit comparing registered and stored iris image information and information on the photographed iris image; and an authentication request device including a short range wireless communication unit performing short range wireless communication with the hand-attached wearable device, a token management unit generating and destroying tokens to be transmitted to the hand-attached wearable device, a decoding unit decoding encoded information received from the hand-attached wearable device, and an iris matching unit comparing the iris image information transmitted from the hand-attached wearable device and registered and stored iris image information, wherein the hand-attached wearable device and the authentication request device establish a primary authentication relationship or a second authentication relationship and a method for controlling the same are provided to maintain a high-level security while increasing convenience of a user by using the iris recognition and the wearing sensing in wireless communication among various devices, and as a result, industrial applicability is high.

1. A wearing-sensing hand-attached wearable device for iris recognition, comprising:
a camera installed on one side of the hand-attached wearable device and photographing an iris image;
an infrared lighting for lighting at the time of photographing the iris image, which is installed on one side of the hand-attached wearable device;
a wireless communication unit transmitting and receiving the iris image information photographed and acquired by the camera; and
a wearing sensing unit sensing whether the hand-attached wearable device is worn on a wrist or finger.

2. A security reinforcing set using a wearing-sensing hand-attached wearable device for iris recognition, comprising:
a wearing-sensing hand-attached wearable device for iris recognition including a camera installed on one side of the hand-attached wearable device and photographing an iris image, an infrared lighting for lighting at the time of photographing the iris image, which is installed on one side of the hand-attached wearable device, a wireless communication unit transmitting and receiving the iris image information photographed and acquired by the camera, and a wearing sensing unit sensing whether the hand-attached wearable device is worn on a wrist or finger; and
an authentication request device including a short range wireless communication unit performing short range wireless communication with the hand-attached wearable device, a token management unit generating and destroying tokens to transmit to the hand-attached wearable device, a decoding unit decoding encoded information received from the hand-attached wearable device, and an iris matching unit comparing the iris image information transmitted from the hand-attached wearable device and registered and stored iris image information,
wherein the hand-attached wearable device and the authentication request device establish a primary authentication relationship.

3. A security reinforcing set using a wearing-sensing hand-attached wearable device for iris recognition, comprising:
a wearing-sensing hand-attached wearable device for iris recognition including a camera installed on one side of the hand-attached wearable device and photographing an iris image, an infrared lighting for lighting at the time of photographing the iris image, which is installed on one side of the hand-attached wearable device, a wireless communication unit transmitting and receiving the iris image information photographed and acquired by the camera, and a wearing sensing unit sensing whether the hand-attached wearable device is worn on a wrist or finger; and
an authentication request device including a short range wireless communication unit performing short range wireless communication with the hand-attached wearable device, a token management unit generating and destroying tokens to transmit to the hand-attached wearable device, a decoding unit decoding encoded information received from the hand-attached wearable device, and an iris matching unit comparing the iris image information transmitted from the hand-attached wearable device and registered and stored iris image information,
wherein the hand-attached wearable device and the authentication request device establish a secondary authentication relationship.

4. A wearing-sensing hand-attached wearable device for iris recognition, comprising:
a camera installed on one side of the hand-attached wearable device and photographing an iris image;
an infrared lighting for lighting at the time of photographing the iris image, which is installed on one side of the hand-attached wearable device;
an iris recognition unit comparing registered and stored iris image information and information on the photographed iris image;
a wearing sensing unit sensing whether the hand-attached wearable device is worn on a wrist or finger; and
a wireless communication unit transmitting/receiving information to/from an authentication request device.

5. A security reinforcing set using a wearing-sensing hand-attached wearable device for iris recognition, comprising:
a wearing-sensing hand-attached wearable device for iris recognition including a camera installed on one side of the hand-attached wearable device and photographing an iris image, an infrared lighting for lighting at the time of photographing the iris image, which is installed on one side of the hand-attached wearable device, an iris recognition unit comparing registered and stored iris image information and information on the photographed iris image, a wearing sensing unit sensing whether the hand-attached wearable device is worn on a wrist or finger; and a wireless communication unit transmitting/receiving information to/from an authentication request device; and
an authentication request device including a short range wireless communication unit performing short range wireless communication with the hand-attached wearable device, a token management unit generating and destroying tokens to transmit to the hand-attached wearable device, and a decoding unit decoding encoded information received from the hand-attached wearable device,
wherein the hand-attached wearable device and the authentication request device establish a primary authentication relationship.

6. A wearing-sensing hand-attached wearable device for iris recognition, comprising:
a wearing-sensing hand-attached wearable device for iris recognition including a camera installed on one side of the hand-attached wearable device and photographing an iris image, an infrared lighting for lighting at the time of photographing the iris image, which is installed on one side of the hand-attached wearable device, an iris recognition unit comparing registered and stored iris image information and information on the photographed iris image, a wearing sensing unit sensing whether the hand-attached wearable device is worn on a wrist or finger; and a wireless communication unit transmitting/receiving information to/from an authentication request device; and
an authentication request device including a short range wireless communication unit performing short range wireless communication with the hand-attached wearable device, a token management unit generating and destroying tokens to transmit to the hand-attached wearable device, and a decoding unit decoding encoded information received from the hand-attached wearable device,
wherein the hand-attached wearable device and the authentication request device establish a secondary authentication relationship.

7. The wearing-sensing hand-attached wearable device for iris recognition of claim 1, wherein the wearing sensing unit is configured to sense wearing by mounting a sensor on a case or band of the hand-attached wearing device.

8. The security reinforcing set using a wearing-sensing hand-attached wearing device for iris recognition of claim 2, wherein the wearing sensing unit is configured to sense wearing by mounting a sensor on a case or band of the hand-attached wearing device.

9. The wearing-sensing hand-attached wearable device for iris recognition of claim 7, wherein the wearing sensor is constituted by one of a spring, a hinge, a magnetic sensor, a capacitive touch sensor, a temperature sensor, and a proximity sensor.

10. The security reinforcing set using a wearing-sensing hand-attached wearing device for iris recognition of claim 8, wherein the wearing sensor is constituted by one of a spring, a hinge, a magnetic sensor, a capacitive touch sensor, a temperature sensor, and a proximity sensor.

11. The wearing-sensing hand-attached wearable device for iris recognition of claim 1, wherein the wireless communication unit comprises:
a short range wireless identification module configured to identify an authentication request device and enable wireless short range communication within a predetermined distance range, and
a session management module managing a session generated while the short range wireless communication is performed.

12. The security reinforcing set using a wearing-sensing hand-attached wearing device for iris recognition claim 2, wherein the wireless communication unit comprises:
a short range wireless identification module configured to identify an authentication request device and enable wireless short range communication within a predetermined distance range, and
a session management module managing a session generated while the short range wireless communication is performed.

13. The wearing-sensing hand-attached wearing device for iris recognition of claim 11, wherein the wireless communication unit further comprises a time-space device authentication module storing and transmitting identification information and time-space information of the hand-attached wearable device performing wireless communication.

14. The security reinforcing set using a wearing-sensing hand-attached wearing device for iris recognition of claim 12, wherein the wireless communication unit further comprises a time-space device authentication module storing the time-space information of the hand-attached wearable device performing the wireless communication and transmitting the time-space information to the authentication request device and identifying the authentication request device by using the time-space information of the authentication request device.

15. The security reinforcing set using a wearing-sensing hand-attached wearing device for iris recognition of claim 2, wherein the short range wireless communication unit comprises:
a session control module controlling a session generated while performing the short range wireless communication with the hand-attached wearable device, and
a wireless identification module transmitting the identification information or the time-space information of the authentication request device to the hand-attached wearing device while performing the short range wireless communication and identifying whether the hand-attached wearing device is a registered device.

16. The wearing sensing hand-attached wearing device for iris recognition of claim 13, wherein the time-space information of the hand-attached wearable device is constituted by at least one of iris image photographing time information of the hand-attached wearable device, location information of the hand-attached wearable device at the time of photographing the iris image, wearing sensing time information of the hand-attached wearable device, or location information of the hand-attached wearable device at the time of sensing the wearing.

17. The security reinforcing set using a wearing-sensing hand-attached wearing device for iris recognition of claim 14, wherein the time-space information of the hand-attached wearable device is constituted by at least one of iris image photographing time information of the hand-attached wearable device, location information of the hand-attached wearable device at the time of photographing the iris image, wearing sensing time information of the hand-attached wearable device, or location information of the hand-attached wearable device at the time of sensing the wearing.

18. The security reinforcing set using a wearing-sensing hand-attached wearing device for iris recognition of claim 15, wherein the time-space information of the authentication request device is constituted by at least one of time information in which the authentication request device requests the hand-attached wearable device to photograph the iris image, location information of the authentication request device at the time of requesting photographing the iris image to the hand-attached wearable device, time Information in which the authentication request device requests the hand-attached wearable device to sense wearing, and location information of the authentication request device when the wearing sensing is requested.

19. The security reinforcing set using a wearing-sensing hand-attached wearing device for iris recognition of claim 2, wherein the primary authentication relationship means a relationship in which the authorization of the resource access of the authentication requesting device is approved after the hand-attached wearable device verifies that the user is the registered wearing user of the hand-attached wearable device at the request of the authentication requesting device.

20. The security reinforcing set using a wearing-sensing hand-attached wearing device for iris recognition of claim 3, wherein the secondary authentication relationship means a relationship in which a mutual secure communication session is maintained between the hand-attached wearable device and the authentication request device after the hand-attached wearable device transmits a registered wearing user verifying key set in order to maintaining the primary authentication relationship established by a request by the authentication request device.

21. The security reinforcing set using a wearing-sensing hand-attachable wearing device for iris recognition of claim 2, wherein device authentication, user authentication, and wearing authentication are performed in order to verify the registered wearing user.

22. The security reinforcing set using a wearing-sensing hand-attached wearing device for iris recognition of claim 21, wherein the device authentication means a process of verifying whether the hand-attached wearing device and the authentication request device connected by the wireless communication are devices which are registered in each other.

23. The security reinforcing set using a wearing-sensing hand-attached wearing device for iris recognition of claim 21, wherein the user authentication means a process of verifying whether the user is a registered wearing user by comparing the iris image information registered and stored through the iris recognition and the photographed iris image information.

24. The security reinforcing set using a wearing-sensing hand-attached wearing device for iris recognition of claim 21, wherein the wearing authentication means a process of verifying whether the user wears the hand-attached wearing device.

25. The security reinforcing set using a wearing-sensing hand-attached wearing device for iris recognition of claim 20, wherein the registered wearing user verifying key set is constituted by one or more tokens or keys that announce a condition in which the device authentication, the authentication, and the wearing authentication are completed and the primary authentication relationship is continued.

26. The security reinforcing set using a wearing-sensing hand-attached wearing device for iris recognition of claim 20, wherein while the secure communication session is performed, even though a request for verifying an additional registered wearing user is required, between the hand-attached wearable device and the authentication request device, the verification of the additional registered wearing user is not performed and a state in which the verification of the additional registered wearing user is completed is maintained.

27. The security reinforcing set using a wearing-sensing hand-attached wearing device for iris recognition of claim 20, wherein the secure communication session stops immediately when the registered wearing user entitlement is released or a request for resetting the secure communication session is received.

28. The security reinforcing set using a wearing-sensing hand-attached wearing device for iris recognition of claim 27, wherein the entitlement release of the registered wearing user occurs when the user releases the wearing of the hand-attached wearable device or when mutual identification is impossible due to movement of the wearable device or the authentication request device or when an effective time of the iris image information has elapsed.

29. The security reinforcing set using a wearing-sensing hand-attached wearing device for iris recognition of claim 27, wherein the request for the secure communication session is executed when the number of secure communication session connection attempts is more than a predetermined criterion.

30. The security reinforcing set using a wearing-sensing hand-attached wearing device for iris recognition of claim 20, wherein when a second authentication request device requests the registered wearing user verification to a first authentication request device while the securer communication session is maintained, the first authentication request device immediately notifies completion of the registered wearing user verification to a second authentication request device without requesting the registered wearing user verification to the hand-attached wearable device.

31. The wearing-sensing hand-attached wearing device for iris recognition of claim 1, wherein the hand-attached wearing device further comprises a security reinforcing unit that encodes the iris image information transferred through the wireless communication.

32. The security reinforcing set using a wearing-sensing hand-attachable wearing device for iris recognition of claim 2, wherein the hand-attached wearing device further comprises a security reinforcing unit that encodes the iris image information transferred through the wireless communication.

33. The wearing-sensing hand-attached wearing device for iris recognition of claim 1, wherein at least one of a unique number, a Pin code, and a one time password (OTP) of the hand-attached wearing device is selected and included in the iris image information to be encoded.

34. The security reinforcing set using a wearing-sensing hand-attachable wearing device for iris recognition of claim 2, wherein at least one of a unique number, a Pin code, and a one time password (OTP) of the hand-attached wearing device is selected and included in the iris image Information to be encoded.

35. The wearing-sensing hand-attached wearing device for iris recognition of claim 31, wherein a token or a key created and transferred from the authentication request device is inserted into the iris image information to encode the iris image information.

36. The security reinforcing set using a wearing-sensing hand-attached wearing device for iris recognition of claim 32, wherein a token or a key created and transferred from the authentication request device is inserted into the iris image information to encode the iris image information.

37. The wearing-sensing hand-attached wearing device for iris recognition of claim 31, wherein a digital watermark is used to encode the iris image information in order to reinforce the security of the iris image information.

38. The security reinforcing set using a wearing-sensing hand-attached wearing device for iris recognition of claim 32, wherein a digital watermark is used to encode the iris image information in order to reinforce the security of the iris image information.

39. The wearing-sensing hand-attached wearing device for iris recognition of claim 1, wherein iris image photographing time information of the hand-attached wearing device or location information of the hand-attached wearing device at the time of photographing the iris image in the iris image information is selected and encoded.

40. The security reinforcing set using a wearing-sensing hand-attachable wearing device for iris recognition of claim 2, wherein iris image photographing time information of the hand-attached wearing device or location information of the hand-attached wearing device at the time of photographing the iris image in the iris image information is selected and encoded.

41. The wearing-sensing hand-attached wearing device for iris recognition of claim 39, wherein the location information of the hand-attachable wearing device is relative positional information using a unique number of a base station or a wireless AP connected with the hand-attachable wearing device or absolute location information using GPS information.

42. The security reinforcing set using a wearing-sensing hand-attached wearing device for iris recognition of claim 40, wherein the location information of the hand-attachable wearing device is relative positional information using a unique number of a base station or a wireless AP connected with the hand-attachable wearing device or absolute location information using GPS information.

43. The security reinforcing set using a wearing-sensing hand-attached wearing device for iris recognition of claim 18, wherein the location information of the authentication request device is relative positional information using a unique number of a base station or a wireless AP connected with the authentication request device or absolute location information using GPS information.

44. The wearing-sensing hand-attached wearing device for iris recognition of claim 1, wherein a display capable of verifying the photographed iris image is added to the hand-attached wearing device.

45. The security reinforcing set using a wearing-sensing hand-attachable wearing device for iris recognition of claim 2, wherein a display capable of verifying the photographed iris image is added to the hand-attached wearing device.

46. The wearing-sensing hand-attachable wearing device for iris recognition of claim 1, wherein the hand-attachable wearing device is a wearable device worn on a wrist or a wearable device worn on a finger.

47. The security reinforcing set using a wearing-sensing hand-attachable wearing device for iris recognition of claim 2, wherein the hand-attachable wearing device is a wearable device worn on a wrist or a wearable device worn on a finger.

48. A method for controlling a security reinforcing set using a wearing-sensing hand-attachable wearing device for iris recognition, which comprises a wearing-sensing hand-attached wearable device for iris recognition including a camera installed on one side of the hand-attached wearable device and photographing an iris image, an infrared lighting for lighting at the time of photographing the iris image, which is installed on one side of the hand-attached wearable device, a wireless communication unit transmitting and receiving the iris image information photographed and acquired by the camera, and a wearing sensing unit sensing whether the hand-attached wearable device is worn on a wrist or finger, and an authentication request device including a short range wireless communication unit performing short range wireless communication with the hand-attached wearable device, a token management unit generating and destroying tokens to transmit to the hand-attached wearable device, a decoding unit decoding encoded Information received from the hand-attached wearable device, and an iris matching unit comparing the iris image information transmitted from the hand-attached wearable device and registered and stored iris image information, the method comprising:
connecting or pairing, by the short-range wireless communication unit of the authentication request device, the short-range wireless communication with the wireless communication unit of the hand-attached wearable device when the hand-attached wearable device accessing the authentication request device approaches within a communicable distance by sensing intensity of a transmitted/received signal;
requesting registered wearing user verification to be performed from the hand-attached wearable device by transmitting a token or a key requesting registered wearing user verification generated from a token manager of the authentication request device to the hand-attached wearable device;
transferring, by the hand-attached wearable device and the authentication request device, iris image information generated from an iris image photographed by a camera of the hand-attached wearable device to an iris matching unit of the authentication request device in order to verify the registered wearing user and comparing the iris image information with the iris image information registered and stored in the iris matching unit to perform user authentication of verifying whether the user is the registered wearing user;
performing wearing authentication of verifying whether the user wears the hand-attached wearable device by the wearing sensing unit of the hand-attached wearable device; and
completing, by the hand-attached wearable device, the registered wearing user verification and notifying, by the wireless communication unit of the hand-attached wearable device, the registered wearing user verification to the authentication request device.

49. A method for controlling a security reinforcing set using a wearing-sensing hand-attachable wearing device for iris recognition, which comprises a wearing-sensing hand-attached wearable device for iris recognition including a camera installed on one side of the hand-attached wearable device and photographing an iris image, an infrared lighting for lighting at the time of photographing the iris image, which is installed on one side of the hand-attached wearable device, a wireless communication unit transmitting and receiving the iris image information photographed and acquired by the camera, and a wearing sensing unit sensing whether the hand-attached wearable device is worn on a wrist or finger, and an authentication request device including a short range wireless communication unit performing short range wireless communication with the hand-attached wearable device, a token management unit generating and destroying tokens to transmit to the hand-attached wearable device, a decoding unit decoding encoded information received from the hand-attached wearable device, and an iris matching unit comparing the iris image information transmitted from the hand-attached wearable device and registered and stored iris image information, the method comprising:
connecting or pairing, by the short-range wireless communication unit of the authentication request device, the short-range wireless communication with the wireless communication unit of the hand-attached wearable device when the hand-attached wearable device accessing the authentication request device approaches within a communicable distance by sensing intensity of a transmitted/received signal;
requesting registered wearing user verification to be performed from the hand-attached wearable device by transmitting a token or a key requesting registered wearing user verification generated from a token manager of the authentication request device to the hand-attached wearable device;
transferring, by the hand-attached wearable device and the authentication request device, iris image information generated from an iris image photographed by a camera of the hand-attached wearable device to an iris matching unit of the authentication request device in order to verify the registered wearing user and comparing the iris image information with the iris image information registered and stored in the iris matching unit to perform user authentication of verifying whether the user is the registered wearing user;
performing wearing authentication of verifying whether the user wears the hand-attached wearable device by the wearing sensing unit of the hand-attached wearable device;
completing, by the hand-attached wearable device, the registered wearing user verification and notifying, by the wireless communication unit of the hand-attached wearable device, the registered wearing user verification to the authentication request device; and
maintaining, by the wireless communication unit of the hand-attached wearable device and the short range wireless communication unit of the authentication request device, a secure communication session.

50. A method for controlling a security reinforcing set using a wearing-sensing hand-attachable wearing device for iris recognition, which comprises a wearing-sensing hand-attached wearable device for iris recognition including a camera installed on one side of the hand-attached wearable device and photographing an iris image, an infrared lighting for righting at the time of photographing the iris image, which is installed on one side of the hand-attached wearable device, an iris recognition unit comparing registered and stored iris image information and information on the photographed iris image, a wearing sensing unit sensing whether the hand-attached wearable device is worn on a wrist or finger; and a wireless communication unit transmitting/receiving information to/from an authentication request device, and an authentication request device including a short range wireless communication unit performing short range wireless communication with the hand-attached wearable device, a token management unit generating and destroying tokens to transmit to the hand-attached wearable device, and a decoding unit decoding encoded information received from the hand-attached wearable device, the method comprising:
connecting or pairing, by the short-range wireless communication unit of the authentication request device, the short-range wireless communication with the wireless communication unit of the hand-attached wearable device when the hand-attached wearable device accessing the authentication request device approaches within a communicable distance by sensing intensity of a transmitted/received signal;
requesting registered wearing user verification to be performed from the hand-attached wearable device by transmitting a token or a key requesting registered wearing user verification generated from a token manager of the authentication request device to the hand-attached wearable device;
transferring, by the hand-attached wearable device, iris image information generated from an iris image photographed by a camera of the hand-attached wearable device to an iris matching unit in order to verify the registered wearing user and comparing the iris image information with the iris image information registered and stored in the iris matching unit to perform user authentication of verifying whether the user is the registered wearing user;
performing wearing authentication of verifying whether the user wears the hand-attached wearable device by the wearing sensing unit of the hand-attached wearable device; and
completing, by the hand-attached wearable device, the registered wearing user verification and notifying, by the wireless communication unit of the hand-attached wearable device, the registered wearing user verification to the authentication request device.

51. A method for controlling a security reinforcing set using a wearing-sensing hand-attachable wearing device for iris recognition, which comprises a wearing-sensing hand-attached wearable device for iris recognition including a camera installed on one side of the hand-attached wearable device and photographing an iris image, an infrared lighting for lighting at the time of photographing the iris image, which is installed on one side of the hand-attached wearable device, an iris recognition unit comparing registered and stored iris image information and information on the photographed iris image, a wearing sensing unit sensing whether the hand-attached wearable device is worn on a wrist or finger; and a wireless communication unit transmitting/receiving information to/from an authentication request device, and an authentication request device including a short range wireless communication unit performing short range wireless communication with the hand-attached wearable device, a token management unit generating and destroying tokens to transmit to the hand-attached wearable device, and a decoding unit decoding encoded information received from the hand-attached wearable device, the method comprising:
connecting or pairing, by the short-range wireless communication unit of the authentication request device, the short-range wireless communication with the wireless communication unit of the hand-attached wearable device when the hand-attached wearable device accessing the authentication request device approaches within a communicable distance by sensing intensity of a transmitted/received signal;
requesting registered wearing user verification to be performed from the hand-attached wearable device by transmitting a token or a key requesting registered wearing user verification generated from a token manager of the authentication request device to the hand-attached wearable device;
performing user authentication of transferring, by the hand-attached wearable device and the authentication request device, iris image Information generated from an iris image photographed by a camera of the hand-attached wearable device to an iris matching unit of the authentication request device in order to verify the registered wearing user and comparing the iris image information with the iris image information registered and stored in the iris matching unit to verify whether the user is the registered wearing user;
performing wearing authentication of verifying whether the user wears the hand-attached wearable device by the wearing sensing unit of the hand-attached wearable device;
completing, by the hand-attached wearable device, the registered wearing user verification and notifying, by the wireless communication unit of the hand-attached wearable device, the registered wearing user verification to the authentication request device; and
maintaining, by the wireless communication unit of the hand-attached wearable device and the short range wireless communication unit of the authentication request device, a secure communication session.

52. The method for controlling a security reinforcing set using a wearing-sensing hand-attachable wearing device for iris recognition of claim 49, wherein in the connecting or pairing, by the short-range wireless communication unit of the authentication request device, the short-range wireless communication with the wireless communication unit of the hand-attached wearable device when the hand-attached wearable device accessing the authentication request device approaches within a communicable distance by sensing intensity of a transmitted/received signal, identifying whether the wireless communication unit of the hand-attached wearable device and the short range wireless communication unit of the authentication request device are devices which are registered in each other is further added.

53. The method for controlling a security reinforcing set using a wearing-sensing hand-attachable wearing device for iris recognition of claim 48, wherein in the performing of the user authentication of transferring, by the hand-attached wearable device and the authentication request device, iris image information generated from an iris image photographed by a camera of the hand-attached wearable device to an iris matching unit of the authentication request device in order to verify the registered wearing user and comparing the iris image information with the iris image information registered and stored in the iris matching unit to verify whether the user is the registered wearing user, performing time-space device authentication using time-space information of the hand-attached wearable device or the authentication request device is added.

54. The method for controlling a security reinforcing set using a wearing-sensing hand-attachable wearing device for iris recognition of claim 50, wherein in the performing of the user authentication of transferring, by the hand-attached wearable device and the authentication request device, iris image information generated from an iris image photographed by a camera of the hand-attached wearable device to an iris matching unit of the authentication request device in order to verify the registered wearing user and comparing the iris image information with the iris image Information registered and stored in the iris matching unit to verify whether the user is the registered wearing user, performing time-space device authentication using time-space information of the hand-attached wearable device or the authentication request device is added.

55. The method for controlling a security reinforcing set using a wearing-sensing hand-attachable wearing device for iris recognition of claim 49, wherein in the performing of the wearing authentication of verifying whether the user wears the hand-attached wearable device by the wearing sensing unit of the hand-attached wearable device, performing time-space device authentication using time-space information of the hand-attached wearable device or the authentication request device is added.

56. The method for controlling a security reinforcing set using a wearing-sensing hand-attachable wearing device for iris recognition of claim 48, wherein the performing of the user authentication of transferring, by the hand-attached wearable device and the authentication request device, iris image information generated from an iris image photographed by a camera of the hand-attached wearable device to an iris matching unit of the authentication request device in order to verify the registered wearing user and comparing the iris image information with the iris image information registered and stored in the iris matching unit to verify whether the user is the registered wearing user further comprises:
encoding the iris image information acquired from the hand-attached wearable device to transfer the encoded iris image information to the short-range wireless communication unit of the authentication request device,
decoding the received encoded iris image information by a decoding unit of the authentication request device,
comparing the decoded iris image information and the iris image information registered and stored in the iris matching unit of the authentication request device to verify whether the user is the registered wearing user, and
notifying, by the short range wireless communication unit of the authentication request device, that verifying whether the user is the registered wearing user is completed to the hand-attached wearable device.

57. The method for controlling a security reinforcing set using a wearing-sensing hand-attachable wearing device for iris recognition of claim 49, wherein the maintaining, by the wireless communication unit of the hand-attached wearable device and the short range wireless communication unit of the authentication request device, a secure communication session further comprises:
transferring and verifying, by the wireless communication unit of the hand-attached wearable device, a user verification key set to the short range wireless communication unit and thereafter, starting, by the wireless communication unit of the hand-attached wearable device and the short range wireless communication unit of the authentication request device, a mutual secure communication session, and
stopping, by the wireless communication unit of the hand-attached wearable device and the short range wireless communication unit of the authentication request device, the mutual secure communication session at a request of releasing the secure communication session.

58. The method for controlling a security reinforcing set using a wearing-sensing hand-attachable wearing device for iris recognition of claim 49, wherein in the maintaining, by the wireless communication unit of the hand-attached wearable device and the short range wireless communication unit of the authentication request device, the secure communication session,
when a second authentication request device requests the registered wearing user verification to a first authentication request device, creating, by the token management unit of the first authentication request device, a token announcing immediately notifying completion of the registered wearing user verification to a second authentication request device without requesting the registered wearing user verification to the hand-attached wearable device and notifying the completion of the registered wearing user verification to the second authentication request device is added.

59. The method for controlling a security reinforcing set using a wearing-sensing hand-attachable wearing device for iris recognition of claim 49, wherein the stopping, by the wireless communication unit of the hand-attached wearable device and the short range wireless communication unit of the first authentication request device, the secure communication session when the wireless communication unit of the hand-attached wearable device and the short range wireless communication unit of the first authentication request device maintains the secure communication session further comprises:
creating and transferring, by the token management unit of the first authentication request device, the token for requesting the registered wearing user verification to the hand-attached wearable device when the second authentication request device requests verifying the wearing user registered in the first authentication request device,
completing, by the hand-attached wearable device, the registered wearing user verification and notifying, by the wireless communication unit of the hand-attached wearable device, the registered wearing user verification to the authentication request device, and
notifying, by the short range wireless communication unit of the first authentication request device, verifying the wearing user registered in the second authentication request device immediately when receiving the notification of the registered wearing user verification from the hand-attached wearable device.
